(19) United States
(12) Patent Application Publication
(10) Pub. No.: US 2018/0128093 A1
(43) Pub. Date: May 10, 2018

(54) METHOD AND APPARATUS FOR DRILL STRING CONTROL

(71) Applicant: Schlumberger Technology Corporation, Sugar Land, TX (US)

(72) Inventors: Benjamin Peter Jeffryes, Histon (GB); Nathaniel Wicks, Somerville, MA (US); Shunfeng Zheng, Katy, TX (US)

(21) Appl. No.: 15/806,776

(22) Filed: Nov. 8, 2017

Related U.S. Application Data
(60) Provisional application No. 62/419,278, filed on Nov. 8, 2016.
(60) Provisional application No. 62/554,239, filed on Sep. 5, 2017.

(51) Int. Cl. E21B 44/02; E21B 3/00; E21B 41/00; G05B 19/042; G05B 19/406; G05B 19/416

(52) U.S. Cl. CPC E21B 44/02; E21B 3/00; E21B 41/0092; G05B 2219/45129; G05B 19/406; G05B 19/4163; G05B 19/042

(57) ABSTRACT

A method and apparatus for controlling a drilling system by: implementing a network of Level 1 direct control processing systems and Level 2 coordinated control processing systems, wherein the level 1 direct control and Level 2 coordinated control processing systems are communicatively coupled to each other; operating the Level 2 coordinated control processing systems to: receive uphole drill string property measurements from sensors associated with the drill string near the driver, execute a control algorithm based on the received drill string property measurements to generation an actuator command, and transmit the actuator command to the Level 1 direct control processing systems; and operating the Level 1 direct control processing systems to control the driver based on the actuator command.

### PRIORITY CLAIM

The application claims priority to U.S. Provisional Patent Application Ser. No. 62/419,278, filed on Nov. 8, 2016, and U.S. Provisional Patent Application Ser. No. 62/554,239, filed Sep. 5, 2017. Both of these applications are incorporated by reference herein.

### TECHNICAL FIELD

The present disclosure relates generally to the field of drilling wells. More particularly, the invention concerns controlling subsystems via a control system implementing control algorithms.

### BACKGROUND

As explained in SPE 18049, slip-stick motion of the bottom hole assembly can be regarded as extreme, self-sustained oscillations of the lowest torsional mode, called the pendulum mode. Such a motion is characterized by finite time intervals during which the bit is non-rotating and the drill pipe section is twisted by the rotary table or top drive. When the drillstring torque reaches a certain level (determined by the static friction resistance of the bottom hole assembly), the bottom hole assembly breaks free and speeds up to more than twice the nominal speed before it slows down and again comes to a complete stop. It is obvious that such motion represents a large cyclic stress in the drill pipe that can lead to fatigue problems. In addition, the high bit speed level in the problems. In addition, the high bit speed level in the slip phase can induce severe axial and lateral vibrations in the bottom hole assembly which can be damaging to the connections. Finally, it is likely that drilling with slip-stick motion leads to excessive bit wear and also a reduction in the penetration rate. Frequency analysis of the driving torque associated with torsional drill string vibrations, in particular slip-stick oscillations, reveals that a large number of torsional drill string resonances. The sharpness of the curve at the drill string resonance frequencies suggest there is little damping of torsional drill string vibrations. Halsey, Kyllingstad, and Kylling, “Torque Feedback Used to Cure Slip-Stick Motion,” SPE 18049, 1988. The authors proposed a speed correction proportional to the torque to control rotational vibrations.

Previously, methods have been proposed for detecting stick-slip and mitigating its effect by changing the rotation speed of the top drive, the weight on bit and/or the like. Other more active methods, have sought to dampen the oscillations of the drillstring in the borehole to prevent stick-slip. However, measures taken to dampen oscillations and prevent stick-slip, for example by adjusting drilling speed, weight on bit and/or the like, may run contrary to and not take account of the drilling parameters necessary/desirable for optimal drilling, such as optimum rate of penetration or the like. Further, a controller may have determined an optimal, desired rate of rotation of the top drive or the like to produce desired drilling of the borehole. Methods of controlling rotational vibrations using a control system have previously been described that provide for reducing the amplitude of a rotational resonance of the drillstring. Such active methods of damping oscillations may adversely affect the rate of drilling and/or move the drilling speed away from the desired rate. Moreover, previously, these damping operations were determined mainly based upon factors for mitigation/prevention of stick-slip.

There is a need for a method and system that reduces or dampens torsional drill string vibrations, in particular slip-stick oscillations and torsional drill string resonances via a well control system that overcomes disadvantages of the conventional designs.

### SUMMARY

In accordance with the teachings of the present disclosure, disadvantages and problems associated with rotational oscillations are overcome by providing a method and system that reduces or dampens torsional drill string vibrations, in particular slip-stick oscillations and torsional drill string resonances via a well construction control system. A slip-stick control algorithm may be implemented in a coordinated industrial control PC running a real time operating system, in a direct control running a field databus, or in a server computer or a virtual machine. Implementing on an industrial PC means implementing “on a middle layer” and implementing on a direct control PLC means implementing “on a bottom layer.”

One aspect of the invention is to run a stick-slip algorithm at any of several layers in a control scheme. Another aspect of the invention is to run an autodriller parameter selection process at any of several layers in a control scheme. Still another aspect of the invention is to run a stick-slip algorithm and an autodriller parameter selection process independently within a control scheme.

According to one aspect of the invention, there is provided a method for controlling a drilling system comprising a driver, drawworks, drillstring and drill bit, wherein the driver rotates the drillstring and the drawworks raises/lowers the drillstring during a drilling process to drill a borehole through an earth formation, the method comprising: implementing a network comprising one or more controllers; operating the one or more controllers, wherein the operating comprises: receiving uphole drill string property measurements from sensors associated with the drill string near the driver, executing a control algorithm based on the received drill string property measurements to generate an actuator command; and operating the driver based on the actuator command.

A further aspect of the invention provides a method for controlling a drilling system comprising a driver, drawworks, drillstring and drill bit, wherein the driver rotates the drillstring and the drawworks raises/lowers the drillstring during a drilling process to drill a borehole through an earth formation, the method comprising: implementing controllers in a network comprising: at least one level 0 (field) variable frequency drive of the driver; at least one level 1 (bottom) direct controller, wherein the at least one level 0 (field) variable frequency drive and the at least one level 1 (bottom) direct controller communicate via a field bus; at least one level 2 (middle) coordinated controller, wherein the at least one level 1 (bottom) direct controller and the at least one level 2 (middle) coordinated controller communicate via a real time databus; operating one or more of the controllers, wherein the operating comprises: receiving uphole drill string property measurements from sensors associated with the drill string near the driver, executing a slip-stick energy optimization algorithm based on the received drill string property measurements to generate a RPM command, comprising: setting a desired rotation speed v₀ for the drillstring; deriving a component vᵤₚ of a rotation speed of the drillstring associated with upgoing rotational energy from the received uphole drill string property measurements; determining a rotation speed v for the drillstring by optimizing an expression which reconciles two conflicting objectives of: (i) maintaining a stable rotation speed centered on v₀, and (ii) minimizing downgoing rotational energy, the optimized expression expressing v in terms of v₀ and vᵤₚ; and generating a RPM command for the driver to rotate the drillstring at v; and operating the driver based on the RPM command.

According to a further aspect of the invention, there is provided a drilling system comprising: a driver, a drawworks, a drillstring; a drill bit, wherein the driver rotates the drillstring and the drawworks raises/lowers the drillstring during a drilling process to drill a borehole through an earth formation; controllers in a network comprising: at least one level 0 (field) variable frequency drive of the driver; at least one level 1 (bottom) direct controller, wherein the at least one level 0 (field) variable frequency drive and the at least one level 1 (bottom) direct controller communicate via a field bus; at least one level 2 (middle) coordinated controller, wherein the at least one level 1 (bottom) direct controller and the at least one level 2 (middle) coordinated controller communicate via a real time databus; wherein each controller comprises a non-transitory storage medium; a set of computer readable instructions stored in the non-transitory storage medium of at least one of the controllers and when executed by the at least one controller is configured to allow the at least one controller to: receive uphole drill string property measurements from sensors associated with the drill string near the driver, execute a slip-stick energy optimization algorithm based on the received drill string property measurements to generate a RPM command, comprising: setting a desired rotation speed v₀ for the drillstring; deriving a component vᵤₚ of a rotation speed of the drillstring associated with upgoing rotational energy from the received uphole drill string property measurements; determining a rotation speed v for the drillstring by optimizing an expression which reconciles two conflicting objectives of: (i) maintaining a stable rotation speed centered on v₀, and (ii) minimizing downgoing rotational energy, the optimized expression expressing v in terms of v₀ and vᵤₚ; and generating a RPM command for the driver to rotate the drillstring at v; and operating the driver based on the RPM command.

Another aspect of the invention provides a method for estimating drilling parameters via an autodriller, the method comprising: drilling a wellbore with a drilling system controlled by the autodriller under a first control parameter; changing the first control parameter; observing changes in the drilling system in response to the changed first control parameter; combining data reflecting the observed changes in the drilling system; estimating an exponential decay factor based on the combined data; deriving second control parameter from the estimated decay factor; and drilling the wellbore with the drilling system controlled by the autodriller under the second control parameter.

### BRIEF DESCRIPTION OF THE DRAWINGS

A more complete understanding of the present embodiments may be acquired by referring to the following description taken in conjunction with the accompanying drawings, in which like reference numbers indicate like features.

FIG. 1 illustrates a schematic diagram of a drill rig being operated to conduct a drilling operation controlled by an autodriller.

FIG. 2 shows a schematic diagram of an autodriller illustrating various components communicating with each other and with sensors and actuators of the drilling system.

FIG. 3 shows a flow chart for a software routine for implementation by the autodriller module, wherein the controlled parameter is rate of penetration.

FIG. 4 shows a flow chart for a software routine for implementation by the autodriller module, wherein the controlled parameter is weight on bit.

FIG. 5 shows a flow chart for a software routine for implementation by the autodriller module, wherein the controlled parameter is pressure.

FIG. 6 shows a graph of pressure as a function of time for a simulation of standard pressure control.

FIG. 7 shows a graph of pressure as a function of time for a simulation of pressure control as herein disclosed.

FIG. 8 shows a flow chart for a software routine for implementation by the autodriller module, wherein the controlled parameter is pressure.

FIG. 9 shows a flow chart for a software routine for implementation by the autodriller module, wherein feed-forward control is used to transition to a second value of weight on bit.

FIG. 10 shows a graph of weight as a function of time for a transition from 10 to 20 klbf over 15 seconds.

FIG. 11 shows a graph of surface rate of penetration as a function of time for a transition from 10 to 20 klbf over 15 seconds.

FIG. 12 shows a graph of weight as a function of time for a transition from 10 to 20 klbf over 15 seconds.

FIG. 13 shows a graph of surface rate of penetration as a function of time for a transition from 10 to 20 klbf over 15 seconds.

FIG. 14 shows a flowchart of autodrill system operations.

FIG. 15 is a flow chart of at least a portion of an example implementation of a slip-stick energy optimization algorithm according to one or more aspects of the present disclosure.

FIG. 16 illustrates a levels of control devices in a control architecture.

FIG. 17A is a flow chart of at least a portion of an example implementation of a control process implementing a slip-stick energy optimization algorithm at Level 2 (Middle).

FIG. 17B is a flow chart of at least a portion of an example implementation of a control process implementing a slip-stick energy optimization algorithm at Level 2 (Middle) with input from process monitoring at Level 3 (Top).

FIG. 17C is a flow chart of at least a portion of an example implementation of a control process implementing a slip-stick energy optimization algorithm at Level 1 (Bottom).

FIG. 17D is a flow chart of at least a portion of an example implementation of a control process implementing a slip-stick energy optimization algorithm at Level 1 (Bottom) with input from downhole measurement data.

FIG. 18 illustrates Level 1 (Bottom) and Level 2 (Middle) control devices in a control network architecture according to certain embodiments of the invention.

FIG. 19 illustrates Level 1 (Bottom), Level 2 (Middle) and Level 3 (Top) control devices in a control network architecture according to certain embodiments of the invention.

FIG. 20 is a schematic view of an example of a direct control Level 1 PLC, HMI and Historian implementation of the invention on a virtual network according to one or more aspects of the present disclosure.

FIG. 21 is a schematic view of an example direct control Level 1 PLC of at least a portion of an example implementation of apparatus according to one or more aspects of the present disclosure.

### DETAILED DESCRIPTION

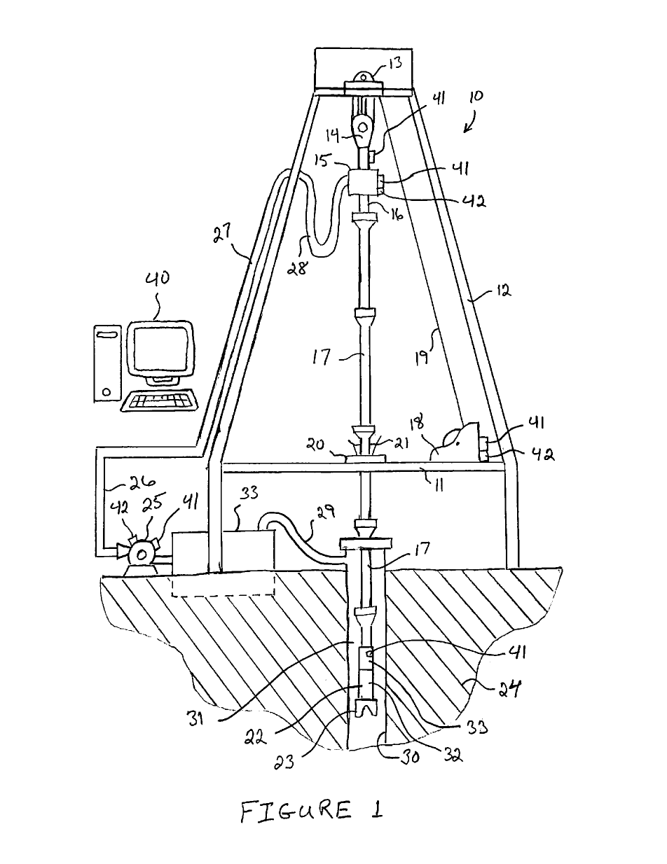

Preferred embodiments are best understood by reference to FIGS. 1-21 below in view of the following general discussion. The present disclosure may be more easily understood in the context of a high level description of certain embodiments. Specific details are given in the following description to provide a thorough understanding of the embodiments. However, it will be understood by one of ordinary skill in the art that embodiments may be practiced without these specific details. For example, well-known circuits, processes, algorithms, structures, and techniques may be shown without unnecessary detail in order to avoid obscuring the embodiments.

FIG. 1 is a basic diagram of a drill rig 10 in the process of drilling a well. The drilling rig 10 comprises a drilling rig floor 11 that is elevated and a derrick 12 that extends upwardly from the floor. A crown block 13 is positioned at the top of the derrick 12 and a traveling block 14 is suspended therefrom. The traveling block 14 may support a top drive 15. A quill 16 extends from the bottom side of the top drive 15 and is used to suspend and/or turn tubular drilling equipment as it is raised/lowered in the wellbore 30. A drill string 17 is made up to the quill 16, wherein the drill string 17 comprises a total length of connected drill pipe stands, or the like, extending into the well bore 30. One or more motors housed in the top drive 15 rotate the drill string 17. A drawworks 18 pays out and reels in drilling line 19 relative to the crown block 13 and traveling block 14 so as to hoist/lower various drilling equipment.

As shown in FIG. 1, a new stand of drill string 17 has been made up as the lower portion of the drill string 17 is suspended from the rig floor 12 by a rotary table 20. Slips 21 secure the suspended portion of the drill string 17 in the rotary table 20. A bottom hole assembly 22 is fixed to the lower end of the drill string 17 and includes: a drill bit 23 for drilling through a formation 24; a positive displacement motor (PDM) 32; and a measurement while drilling (MWD) module 33.

During the drilling process, drilling mud may be circulated through the wellbore 30 to remove cuttings from around the drill bit 23. A mud pump 25 pumps the drilling mud through a discharge line 26, stand pipe 27, and rotary hose 28 to supply drilling mud to the top drive 15. Drilling mud flows from the top drive 15 down through the drill string 17, where it exits the drill string 17 through the drill bit 23. From the drill bit 23, the drilling mud flows up through an annulus 31 existing between the wellbore 30 and the drill string 17 so as to carry cuttings away from the drill bit 23. A return line 29 allows the drilling mud to flow from the top of the annulus 31 into a mud pit 33. Of course, the mud pump 25 is supplied drilling mud from the mud pit 33. The drilling mud typically passes through a series of shakers, separators, etc. (not shown) to separate the cuttings from the drilling mud before the mud is circulated again by the mud pump 25.

Referring again to FIG. 1, an autodriller 40 may be used to control the drilling process. The autodriller 40 may be configured to receive drilling parameter data and drilling performance data related to operations of the drilling rig 10. The drilling parameter data and drilling performance data may comprise measurements monitored by a number of sensors 41 placed about the drilling rig 10, e.g., on the drawworks 18, the traveling block 14, the top drive 15, the mud pump 25, and the measurement while drilling (MWD) module 33 as shown in the illustrated embodiment. The sensors 41 may monitor current, voltage, resistivity, force, position, weight, strain, speed, rotational speed, or any other measurement related to drilling parameters or drilling performance, and relevant input may be aggregated as raw sensor measurements or as scaled engineering values. The autodriller 40 may receive drilling parameter data and drilling performance data directly from the sensors 41, retrofitted to certain pieces of equipment on the drilling rig 10, such that the sensors 41 effectively form part of the drilling system. This type of data acquisition may allow for higher sampling rates to be used for monitoring relevant drilling parameters and drilling performance metrics.

Several components of the drill rig 10 may also comprise control actuators 42. For example, the drawworks 18 may comprise an actuator 42 that allows the autodriller 40 to control the workings of the drawworks 18. The top drive 15 and mud pump 25 may also have actuators 42. The actuators 42 allow the autodriller 40 to control various aspects of the drilling process, for example: bit rotation speed, drill string rotation direction, weight on bit, drilling mud fluid pressure, drilling mud fluid flow rate, drilling mud density, etc.

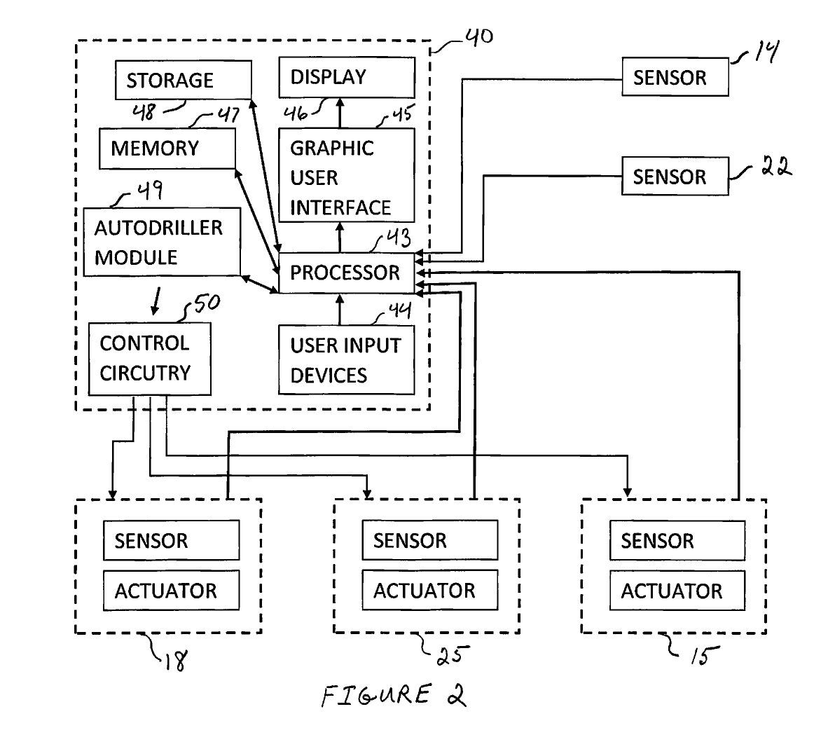

Referring to FIG. 2, a schematic of an autodriller 40 and other drilling rig components is illustrated. The autodriller 40 may comprise a processor 43 that may receive various inputs, such as the drilling parameter data and drilling performance data, from sensors 41. In addition, the processor 43 may be operably coupled to a memory 47 and a storage 48 to execute computer executable instructions for carrying out the presently disclosed techniques. These instructions may be encoded in software/hardware programs and modules that may be executed by the processor 43. The computer codes may be stored in any suitable article of manufacture that includes at least one tangible non-transitory, computer-readable medium (e.g., a hard drive) that at least collectively stores these instructions or routines, such as the memory 47 or the storage 48. An autodriller module 49 may comprise hardware/software for providing autodriller control.

In some embodiments, the autodriller control algorithms may be located in the autodriller module 49. In other embodiments, the autodriller control algorithms may be located on programmable logic controllers (PLCs) that control the drilling rig actuators themselves. In some embodiments, the autodriller control algorithms may be implemented in a software layer above the PLC layer. For example, the autodriller control algorithm would compute the commanded ROP to send to the fast-acting P-I controller on drawworks speed.

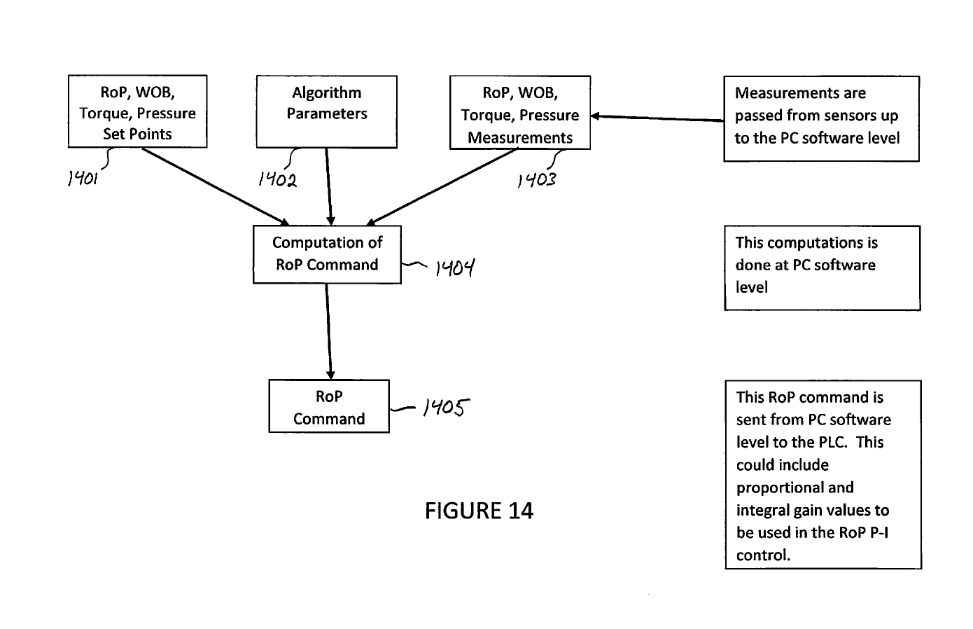

Referring to FIG. 14, a flowchart for autodrill system operations is illustrated. Set points for RoP, WOB, Torque and Pressure may be set at step 1401. Autodrill algorithm parameters may be set at step 1402. Measurements for RoP, WOB, Torque and Pressure may be taken or recorded at step 1403. The set points, algorithm parameters and measurements may be used to compute an RoP command at step 1404. An RoP command is communicated to a PLC at step 1405. Steps 1401 and 1402 may be low frequency information (seconds-minutes). Steps 1403, 1404 and 1405 may be higher frequency information (˜50-100 Hz). Further, as indicated in FIG. 14, the measurements taken or recorded at step 1403 may be passed from sensors up to the PC software level. The computation of the RoP command at step 1404 may be done at the PC software level. The RoP command may be sent at step 1405 from the PC software level to the PLC, which command may include proportional and integral gain values to be used in the RoP P-I control.

In an alternative embodiment, all of the autodrill system operations illustrated in FIG. 14 may be done on the PLC level.

The autodriller 40 may also comprise a display 46 coupled with the processor 43 to visibly display a Graphic User Interface 45. The Graphic User Interface 45 may show to the drill rig operator the drilling parameter data, drilling performance data, and calculated values in real time. Other values derived from the drilling parameter data and drilling performance data may also be displayed. Audible indication devices may output an alarm or other audible indication to alert the drilling operator of the outset of a drilling issue and an appropriate parameter adjustment for mitigating the issue. The autodriller 40 may be equipped with control circuitry 50 to control certain drilling parameters of the drilling rig 10, such that an adjustment determined by the autodriller module 49 may be automatically implemented in the appropriate drilling equipment. For example, if the autodriller module 49 determines that the flow rate of the drilling mud should be increased, the control circuitry 50 may automatically signal the pump 25 to increase the flow rate.

The Graphic User Interface 45 may showing traces related to certain drilling parameter data and performance data that may be used to identify and mitigate drilling issues (e.g., bit-balling, stick/slip vibrations, etc.) in accordance with present techniques. The Graphic User Interface 45 may show traces for drilling parameter values that may be aggregated in real-time or with an inherent delay during drilling operations. In addition to numerical readouts, the Graphic User Interface 45 may show traces of drilling parameter values monitored by the sensors 41, including traveling block height, wellbore depth, drill bit depth (aligned with the well depth), torque of a drilling feature (e.g., the drill bit 23), weight on bit WOB, hook-load, rotational speed (RPM) of a drilling feature (e.g., the drill bit 23), flow rate of drilling mud, stand pipe pressure (SPP), and hydraulic horsepower per square inch (HIS) of drilling mud. Other drilling parameter values may be received from the sensors 41 or interpreted from sensor data, and some drilling parameter values may be related to others or monitored using the same sensors (e.g., WOB and hook-load). In some embodiments, different illustrative techniques may be employed for data representation.

A drilling performance value may be received by the system and traced on the Graphic User Interface 45 with respect to time. The drilling performance value is a value indicative of drilling progression, e.g., rate of penetration (ROP) of the drill string 17 progressing downward into the wellbore 30. In some embodiments, the drilling performance value may be a monitored or calculated drilling efficiency metric. As previously noted, drilling performance values such as the ROP may be affected by the drilling parameter values throughout drilling operation. For example, increasing the WOB provides a greater amount of force to the drill bit 23 for cutting into the formation 24, thereby increasing the ROP. The drilling parameters may affect the ROP in different ways depending on the equipment used on the particular drilling rig 10, the sharpness or dullness of the drill bit 23, and certain lithological features of the formation 24, as will be apparent to one skilled in the art. For example, a combination of drilling parameters that may produce a satisfactory level of the ROP in one formation may produce less desirable performance results in another formation.

The autodriller 40 controls the vertical movement of the drill string so as to keep a drilling parameter at a set value, i.e., weight, or surface rate-of-penetration (ROP), or pressure. The autodriller 40 uses some form of a proportional-integral (PI) controller, which has two parameters in addition to the constant parameter—the proportional and the integral gains. The transient behavior of the drilling system as the set value is changed, depends both on these parameters and parameters that describe the dynamics of the drilling process. The autodriller 40 of the present invention combines data acquired during both transients and when at set values to estimate drilling process parameters and to optimize the PI controller parameters.

A good model for describing the relationship between the motion of the top and bottom of a drill string and the weight-on-bit is

$${v}_{surface} {v}_{bit} = λ \frac{dW}{dt} \qquad ( 1 )$$

Where v_{surface} is the velocity of the top of the drill string, v_{bit} is the velocity of the bit, W is the weight-on-bit, and λ is the compliance of the drill string and system between the two velocity measuring points.

The bit velocity (rate-of-penetration) (ROP) will normally depend on the weight-on-bit, and in normal circumstances will increase as weight increases. For many bits, a linear dependency is appropriate

v_{bit}=k(W Wₒ) (2)

where k is a constant, and Wₒ is an offset which may be zero. Even if the dependency is not linear, then it still may be describable using equation (2) over small weight variations.

Modern auto-drillers can control precisely the rate at which the drill string moves down. They can therefore drill at a controlled surface rate-of-penetration (ROP) without any additional control architecture. In order to control another variable using surface ROP an additional control loop is required. The most common variables used for control are weight-on-bit (WOB) pressure and torque. The invention can be used for WOB control and for torque control.

If drilling is steady at surface ROP v₁, under ROP control, and the rock is uniform, then WOB will be roughly constant too and given by

$${W}_{1} = {W}_{0} + \frac{{v}_{1}}{k}$$

If the surface ROP is changed to v₂ then after a transitional time it will asymptote to weight W₂

$${W}_{2} = {W}_{0} + \frac{{v}_{2}}{k}$$

Combining equations (1) and (2), and solving for weight, the transition will be exponential between the two weights. If the surface ROP is changed at time t₁, then the weight will follow

$$W ( t ) = {W}_{2} + ( {W}_{1} + {W}_{2} ) {e}^{( - η ( t - {t}_{1} ) )}$$

$$Where$$

$$η = \frac{λ}{k}$$

The inverse of η has the units of time, and is often referred to as the drill-off time, as if v₂ is zero, then the end-weight is zero (or at least the weight at which drilling ceases). If this exponential transition can be captured, then the rate-constant η can be determined from the data (for instance using Prony's method). The data may be noisy, however by making small changes in opposing directions at long enough intervals, the results can be summed (with a sign appropriate to the sign of the change in surface ROP), and the rate constant determined from the summed data.

Weight on Bit Control

A common control method is proportional-integral (PI) control. The surface ROP is set as

$${v}_{surface } = a ( \begin{matrix}W & {W}_{d}\end{matrix} ) \frac{a}{τ} \int ( \begin{matrix}W & {W}_{d}\end{matrix} ) \qquad ( 3 )$$

where a and τ are constants, W_{d} is the desired WOB (normally constant, but which can vary), and the integral denotes a sum over past times.

Whatever the surface ROP, the downhole ROP can be written as

v_{bit}(t)=η∫_{x=-∞}^{s=0}v_{Surface}(t+s)e^{ηs}
If drilling is conducted under weight control then equations (1), (2) and (3) must be solved simultaneously. Equating v_{surface} in equations (2) and (3), and differentiating leads to the differential equation.

$$\frac{a}{τ} {W}_{d} = \frac{a}{τ} W + ( a + k ) \frac{dW}{dt} + λ \frac{{d}^{2} W}{{dt}^{2}} \qquad ( 4 )$$

The kernel of this differential equation has two solutions, exponential with rate constants x⁺ and x⁻ given by

$${x}^{\pm } = \frac{( a + k )}{2 λ} \pm \sqrt{( \begin{matrix}\frac{{( a + k )}^{2}}{4 {λ}^{2}} & \frac{a}{λ τ}\end{matrix} )} \qquad ( 5 )$$

The response of the system to step changes in parameters at time to will be a sum of exponential decays with decay rates x⁺ and x⁻, thus by making a change to the desired WOB, and observing the resulting effect on surface ROP and weight, through the use of Prony's method or any other method for determining the rate constants (for instance, fitting to the theoretical solution), the constants x⁺ and x⁻ may be estimated and from these, the values of k and λ (or various combinations of them)

$$λ = \frac{a}{τ {x}^{+} {x}^{-}}$$

$$k = ( {x}^{+} + {x}^{-} ) λ a$$

Rewriting equation (5)

$${x}^{\pm } = \frac{( a + k )}{2 λ} ( 1 \pm \sqrt{( \begin{matrix}1 & \frac{{τ}_{0}}{τ}\end{matrix} )} ) \\ Where \\ {τ}_{0} = \frac{4 a λ}{{( a + k )}^{2}} \qquad ( 6 )$$

Thus while the control parameter a (the proportional control gain), in conjunction with the drilling parameters k and λ, governs the overall convergence of the control system when subject to disturbances, the ratio of τ to τ₀ controls the amount of oscillation. Many autodrillers allow the operator to adjust the proportional and integral gains, but the ratio between the two (corresponding to the time τ) is kept constant. Having estimated λ and k (either from the response to changes in desired weight, or by other methods), for a chosen proportional gain, the system can now automatically set r as in terms of τ₀. If the ratio of τ₀ to τ is one, then there is little or no oscillation. If the ratio of τ₀ to τ is two, then there is a small amount of overshoot. Additionally, the proportional control parameter a can be chosen so that it is in a fixed relationship with the drilling constant k, for instance a can be chosen to be twice k. This has the advantage of keeping the surface velocity swings seen during changes in parameter fairly consistent. Alternatively the proportional control parameters a and τ can be chosen so that the rate constants x⁺ and x⁻ stay constant over time. For known λ and k, choose a and τ so that x⁺ and x⁻ according to equation (6) have the desired values.

Referring to FIG. 4, a flow chart is shown for an embodiment of the autodrill module software. The software, when executed by the process, is configured to: drill with the autodriller under weight on bit control 401: change the controlled weight on bit 402: observe system responses to the changed controlled weight on bit 403; combine data from the observed system responses 404; estimate exponential decay factor 405; derive drilling parameters from the estimated exponential decay factor 406; and drill with the autodriller applying the derived drilling parameters 407.

Pressure Control

One common mode of control when the drill string contains a positive displacement motor (PDM) is to use pressure control. When pressure is the control parameter, the drilling system may go into oscillation. An aspect of the present invention avoids unstable oscillations.

The pressure drop across a positive displacement motor (PDM) is approximately proportional to the torque to which the motor is subjected, and for a PDM close to the bit, the torque is approximately the bit torque—and under normal conditions the bit torque increases as the weight increases. Thus, the pressure drop across the PDM increases and decreases when drilling a uniform rock as the weight increases and decreases. Since the pressure at the surface increases when the pressure across the PDM increases, controlling surface pressure using proportional-integral (PI) control on the pressure is normally regarded as being similar to PI control on weight. There is however a significant difference that arises from the compliance of the fluid inside the drill string.

A similar equation to equation (1) governs the fluid flow in the drill string. Ignoring pressure drops along the drill string,

$${q}_{surface} {q}_{bit} = Λ \frac{dP}{dt}$$

Where q_{surface} is the flow rate at the surface, q_{bit} is the flow rate through the motor and bit, P is the pressure and A is the fluid compliance.

Rearranging

$${q}_{bit} = {q}_{surface} Λ \frac{dP}{dt}$$

The pressure at the surface is the sum of the pressure drop through the bit and the pressure drop across the motor, and the pressure drop through the bit is proportional to the flow rate through the bit squared. Thus if the bit pressure drop when the flow through the bit is the same as the surface flow is given by

$${P}_{bit 0} = \frac{1}{2} χ {q}_{surface}^{2}$$

$$Then$$

$${P}_{bit} \approx {P}_{bit 0} χ Λ {q}_{surface} \frac{dP}{dt} = {P}_{bit 0} \frac{2 Λ {P}_{bit 0}}{{q}_{surface}} \frac{dP}{dt}$$

Thus if the proportionality between the pressure drop across the PDM and the weight on bit is a, then for the surface pressure, approximately

$$P + γ \frac{dP}{dt} = α W \\ Where \\ γ = \frac{2 Λ {P}_{bit 0}}{{q}_{surface}} \qquad ( 7 )$$

The PI control law for the surface velocity may be written as

$${v}_{surface} = a ( P {P}_{d} ) \frac{a}{τ} {\int }_{ }^{ } ( P {P}_{d} ) \qquad ( 8 )$$

where P_{d} is the desired surface pressure.

And combining equations (1), (2), (7) and (8) gives the third order differential equation

$$\frac{a}{τ} {P}_{d} = \frac{a}{τ} P + ( a + \frac{k}{α} ) \frac{dP}{dt} + \frac{λ + k γ}{α} \frac{{d}^{2} P}{{dt}^{2}} + \frac{λγ}{α} \frac{{d}^{3} P}{{dt}^{3}}$$

The response of the system to changes is governed by the roots of the third order equation derived from the coefficients of the right-hand-side of the differential equation

$$0 = \frac{a α}{τλγ} + ( \frac{a α + k}{γλ} ) x + ( \frac{1}{γ} + \frac{k}{λ} ) {x}^{2} + {x}^{3} \qquad ( 9 )$$

In order for responses to be stable, all the roots of this equation must have non-positive real parts. An equation of this form, where all coefficients are positive, will either have three real roots, all of which are negative, or one negative real root and a pair of complex conjugate roots. For a general equation with positive coefficients of the form

0=x³+Ax²+Bx+C

the roots will have negative real parts if

C AB<0

Thus a condition for stability is that

$$\frac{1}{τ} < ( \frac{1}{γ} + \frac{k}{λ} ) ( 1 + \frac{k}{a α} ) \qquad ( 10 )$$

A preferred situation for control is when the three roots of the equation coincide, in which case

$$B = \frac{{A}^{2}}{3}$$

$$C = \frac{{A}^{3}}{27}$$

Or alternatively

$$\begin{matrix}α = \frac{1}{α} [ \frac{{( λ + k γ )}^{2}}{3 λγ} k ] \\ = \frac{1}{3 α} [ \frac{λ}{γ} + \frac{γ {k}^{2}}{λ} k ]\end{matrix} \\ \frac{a}{τ} = \frac{1}{α} \frac{{( λ + k γ )}^{3}}{27 {( λγ )}^{2}} \qquad ( 11 )$$

If the constants in these equations can be estimated, either from calculations based on the known geometries of the drill string and properties of the rock, or from observations, or from some combination of the two, then equation (11) can be used to set the control gains. From equation (10) we see that if instability arises then, it is because the integral gain time constant, is too small, thus a suitable response to observing instability is to increase the time constant until the instability disappears (This is not possible in conventional systems where the time constant is a fixed system parameter). Note that although the analysis of the differential equation might indicate that with unstable roots, oscillations grow exponentially, because in practice there are bounds on the surface velocity—in particular normally motion has to be downwards, so it is bounded below by zero—oscillations will grow and then stabilize at a fixed level. A simulation of an example of this is shown in FIG. 7. A simulation of the response with an increased integral gain time constant T is shown in FIG. 8.

A slightly more sophisticated analysis shows that as the pressure increases, there is a reduction in rate of penetration at constant weight due to the reduction in flow rate through the motor leading to a reduced rate of rotation of the motor and the drill bit. Taking this through the analysis leads to a reduction in quadratic coefficient A in the cubic equation, thus leading to instability over a slightly wider range of integral gains. The bit velocity equation may be written

v_{b}=k′(ω_{d}+ωₘ)W

Where ω_{d} is the drill string rotation speed and ωₘ is the motor rotation speed, and k′ is a constant.

Since motor rotation speed is proportional to flow rate, and flow rate is surface flow rate minus compliance times the rate of change of pressure

$${v}_{b} = {k}^{′} ( {ω}_{d} + φ ( {Q}_{0} Λ \frac{dP}{dt} ) ) W$$

Where ϕ is a constant that depends on the motor.

Linearising for stability analysis

$${v}_{b} = k W ψ \frac{dP}{dt}$$

For a positive constant ψ which may be obtained in terms of the other terms defined above Taking this through leads to the differential equation

$$\frac{a}{τ} {P}_{d} = \frac{a}{τ} P + ( a + \frac{k}{α} ) \frac{dP}{dt} + \frac{λ + k γ - ψ}{α} \frac{{d}^{2} P}{{dt}^{2}} + \frac{λγ}{α} \frac{{d}^{3} P}{{dt}^{3}} \qquad ( 12 )$$

The stability criterion is now

$$\frac{1}{τ} < ( \frac{1}{γ} + \frac{k}{λ} \frac{ψ}{λγ} ) ( 1 + \frac{k}{a α} ) \qquad ( 13 )$$

(Note that this reduces the parameter range for stability).

And the preferred control situation

$$\begin{matrix}\begin{matrix}a = \frac{1}{α} [ \frac{{( λ + k γ - ψ )}^{2}}{3 λγ} k ] \\ = \frac{1}{3 α} [ \frac{λ}{γ} + \frac{γ {k}^{2}}{λ} + \frac{{ψ}^{2}}{λγ} k 2 ψ ( \frac{1}{γ} + \frac{k}{λ} ) ]\end{matrix} & ( 14 ) \\ \frac{a}{τ} = \frac{1}{α} \frac{{( λ + k γ - ψ )}^{3}}{27 {( λγ )}^{2}} & \end{matrix}$$

If the system is not unstable (and it can always be made stable by increasing the parameter τ until oscillations die away), then by making small changes to the system and observing the response in surface velocity, weight and pressure, and then using a method such as Prony's method, the exponential solutions to equation (9) can be estimated and from these the various parameters of the system. Alternatively, some of the parameter can be determined by other means (for instance the time constant γ can be estimated by observing the time for the surface pressure to drop to zero when the pumps are stopped) and these combined with the exponential decays to estimate parameters. The parameters k, λ, α and ψ may also be obtained by other means, such as from the steady state response of the system, and from theoretical calculations. However they are obtained, these may then be used in the choice of gains for the PI controller. They may be used to choose the parameter r that is stable according to equation (10) or preferably equation (13). They may be used to choose both a and r, according to equations (11) or (14).

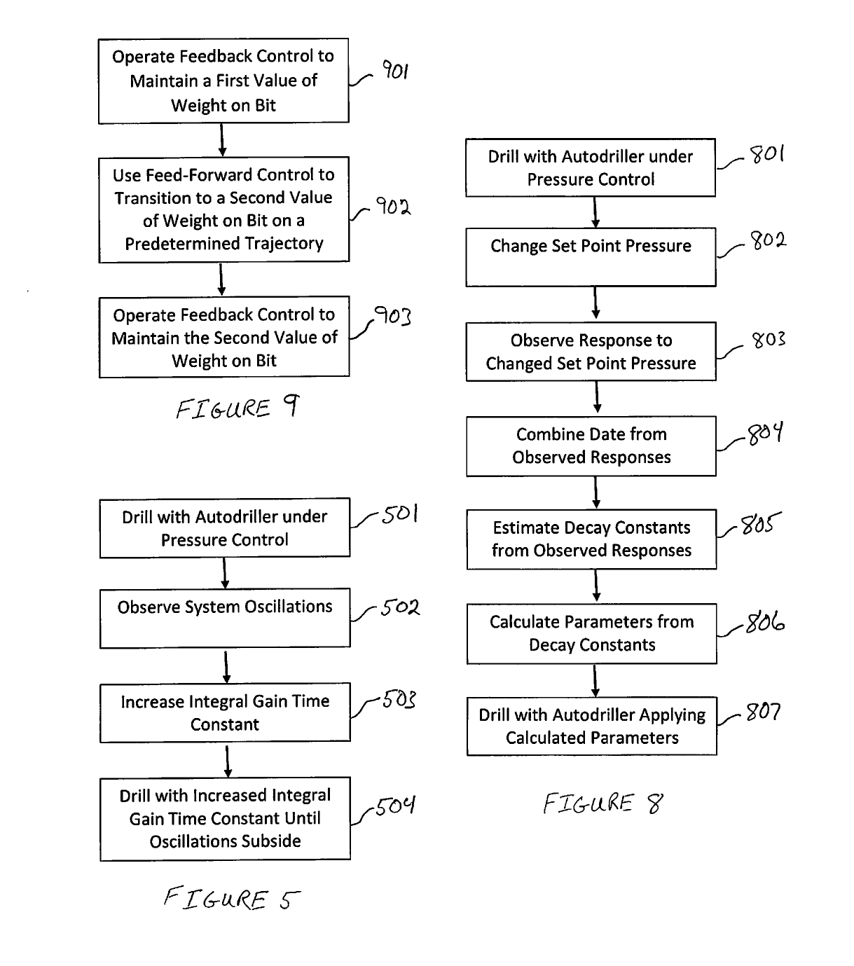

Referring to FIG. 5, a flow chart is shown for an embodiment of the autodrill module software. The software, when executed by the process, is configured to: drill with the autodriller under pressure control 501: observed system oscillations 502; increase integral gain time constant 503: and drill with increased integral gain time constant until the oscillations subside 504.

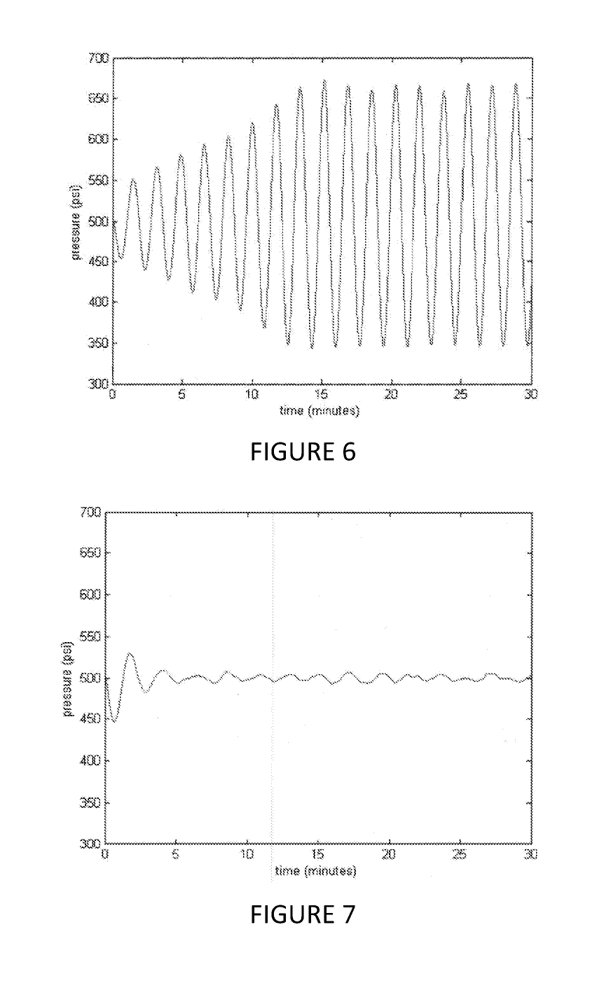

FIG. 6 is a simulation of unstable oscillations resulting from too low a value of r, wherein a standard pressure control was used.

FIG. 7 is a simulation of the response to the same disturbance as in FIG. 6, with a reduced value of τ, wherein a pressure control has herein described was used.

Referring to FIG. 8, a flow chart is shown for an embodiment of the autodrill module software. The software, when executed by the process, is configured to: drill with the autodriller under pressure control 801; change the set point pressure 802; observe system responses to the changed set point pressure 803; combine data from the observed system responses 804; estimate decay constants from the observed responses 805; calculate parameters from the decay constants 806; and drill with the autodriller applying the calculated drilling parameters 807.

### Rate of Penetration

Conventional autodrillers employ proportional-integral (PI) controllers on the surface ROP (the rate of descent of the top of the drill string) in order to control weight. Thus for instance,

$${v}_{surface} = a ( W {W}_{d} ) \frac{a}{τ} {\int }_{ }^{ } ( W {W}_{d} ) \qquad ( 15 )$$

where a and τ are constants, W_{d} is the desired WOB and the integral denotes a sum over past times. Such a system can maintain a very constant WOB as drilling progresses. If it is determined that a different WOB is desired, then W_{d} changes, and the system undergoes a transient response, which will usually last some seconds. In order to avoid weight changes inducing unwanted vibration in the drill string, it may be desirable to make a gradual variation in WOB from one value to another, over a predetermined period. Often it is desired for WOB to change linearly with time from one value to another, thus during the transitional period it is desirable to use a different control method that will achieve a change in WOB close to that desired, and then revert to a PI control once the change has been made. The surface velocity and bit velocity differ due to the compliance of the drill string, and the bit velocity depends on WOB, normally in a way that is approximately linear. Thus

$$\begin{matrix}{v}_{surface} {v}_{bit} = λ \frac{dW}{dt} & ( 16 ) \\ {v}_{bit} = k ( W {W}_{0} ) & ( 17 )\end{matrix}$$

Where v_{surface} is the velocity of the top of the drill string, v_{bit} is the velocity of the bit, W is the weight-on-bit, k is a constant, W_{O} is a weight offset, and λ is the compliance of the drill string and system between the two velocity measuring points. Thus

$${v}_{surface} = k ( W {W}_{0} ) + λ \frac{dW}{Dt} \qquad ( 18 )$$

If it is proposed that the weight follow a defined trajectory versus time, and the quantities k, W₀ and λ are known (or can be estimated) then equation (4) may be used to deterministically control the motion of the top of the drill string. Over long periods, due to the inexact nature of the model, the actual weight will diverge from the proposed weight, however if the model is used for short periods and then feedback control (such as the PI control mechanism of equation) resumes, the actual weight will follow the desired weight sufficiently closely.

If the weight is proposed to change linearly from W₁ to W₂ over time T and the initial surface velocity is v₁, then for the duration of the transition, the surface velocity will be

$${v}_{surface} ( t ) = {v}_{1} ( 1 + \frac{{W}_{2} - {W}_{1}}{{W}_{1} - {W}_{0}} \frac{t}{T} ) + λ ( \frac{{W}_{2} - {W}_{1}}{T} ) for t < T \\ {v}_{surface} ( T ) = {v}_{1} ( \frac{{W}_{1} - {W}_{0}}{{W}_{1} - {W}_{0}} ) \qquad ( 19 )$$

At the end of the change in weight, the Integral term in the PI control system must be updated. Before the change in weight, if the weight is close to the target weight W_{d}, equation (15) becomes

$${v}_{surface} = \frac{a}{τ} {\int }_{ }^{ } ( W {W}_{d} )$$

Writing

l(t)=f(w W_{d})

This implies

$$I ( t ) \approx \frac{τ k}{a} ( W {W}_{0} ) for t < 0$$

If at the end of the weight change, the weight has achieved the level W₂, and the weight tracked the change closely, then the surface velocity will simply revert to the original value, creating a new transient

In order to avoid this, the integral term must be close to that necessary to achieve a stable weight, thus when PI control restarts for t>T

$$I ( T ) = \frac{{W}_{2} - {W}_{0}}{{W}_{1} - {W}_{0}} I ( 0 )$$

after which PI control resumes. Even if the drilling quantities (W₀, k, λ) are only known approximately, once feedback control resumes, the feedback control will ensure that the weight stays close to the target weight, and so long as the errors are small, any transients on restarting feedback control will be small. If the drilling quantities have not been correctly estimated, or there is a change in drilling while the ramp is in progress (for instance, a different rock is penetrated), then the change in weight may be appreciably different to that anticipated. If the result is that the change after the ramp is less than desired, then when PI control resumes, the system will quickly move to the desired weight with little ill-effect. If the system overshoots, then it may, for instance, result in excessive weight-on-bit. Therefore, a desirable modification of the control is that the feed-forward control is aborted once the weight reaches the target weight if this is achieved before the end of the ramp time.

Often there are limits on the allowed values of v_{surface}. Most drilling rigs only allow the travelling block to descend during drilling, so v_{surface} cannot be negative. A maximum value of v_{surface} will often also be imposed. With limit constraints, the desired surface velocity according to equation (19) may not be allowed.

There may be a number of preferred time-intervals for changing weight, for instance to avoid exciting resonances of the drill string, in which case if the first time interval chosen for transition results in values of the surface velocity which are outside of the allowed value, then the smallest preferred time-interval can be chosen for which the surface velocity according to equation (19) does not exceed allowed values.

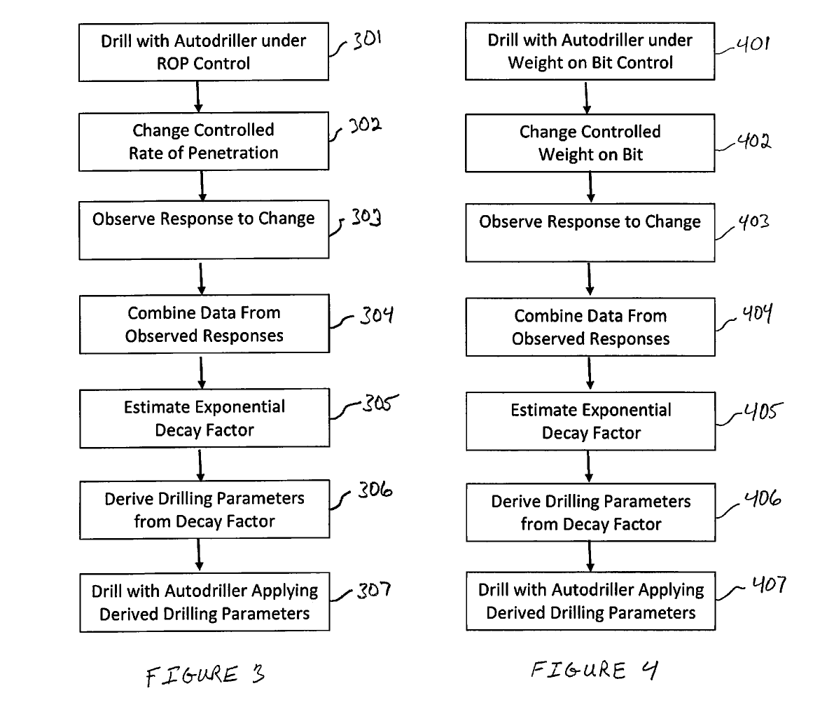

Referring to FIG. 3, a flow chart is shown for an embodiment of the autodrill module software. The software, when executed by the process, is configured to: drill with the autodriller under ROP control 301; change the controlled rate of penetration 302; observe system responses to the changed controlled rate of penetration 303: combine data from the observed system responses 304: estimate exponential decay factor 305; derive drilling parameters from the estimated exponential decay factor 306; and drill with the autodriller applying the derived drilling parameters 307.

Referring to FIG. 9, a flow chart is shown for an embodiment of the autodrill module software. The software, when executed by the process, is configured to: operate feedback control to maintain a first value of weight on bit 901; use feed-forward control to transition to a second value of weight on bit on a predetermine trajectory 902: and operate feed back control to maintain the second value of weight on bit 903.

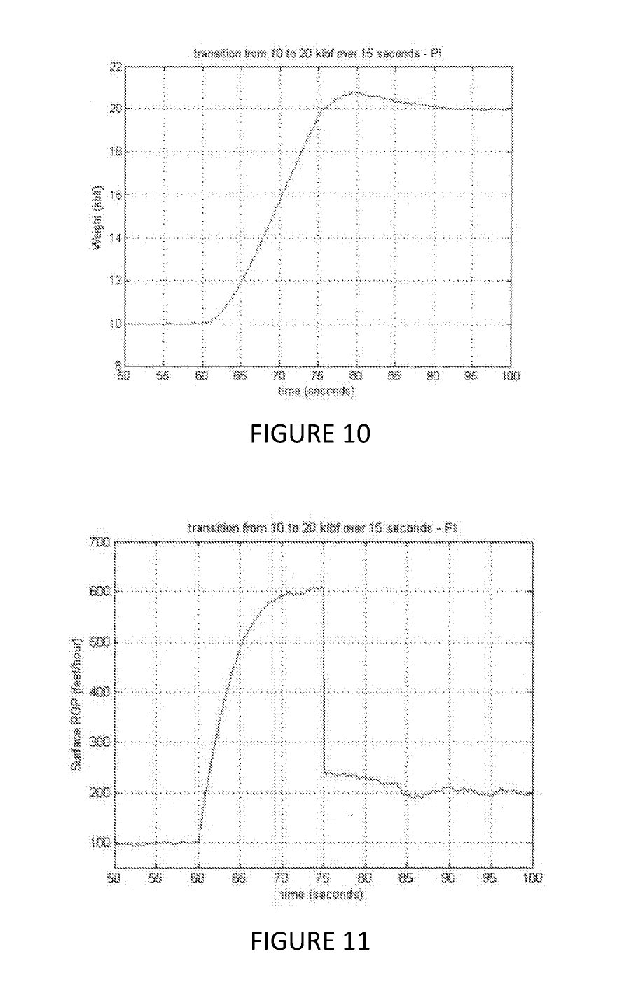

FIGS. 10 and 11 show a simulation of 15 second transition for a 5000 m drill string, drilling a rock with some variability, where a conventional PI controller is used for the transition. FIG. 10 shows weight change over a 15 second transition—conventional controller. The transition starts at 60 seconds and continues to 75 seconds. FIG. 11 shows the velocity of the travelling block (surface ROP) change over a 15 second ramp—conventional controller.

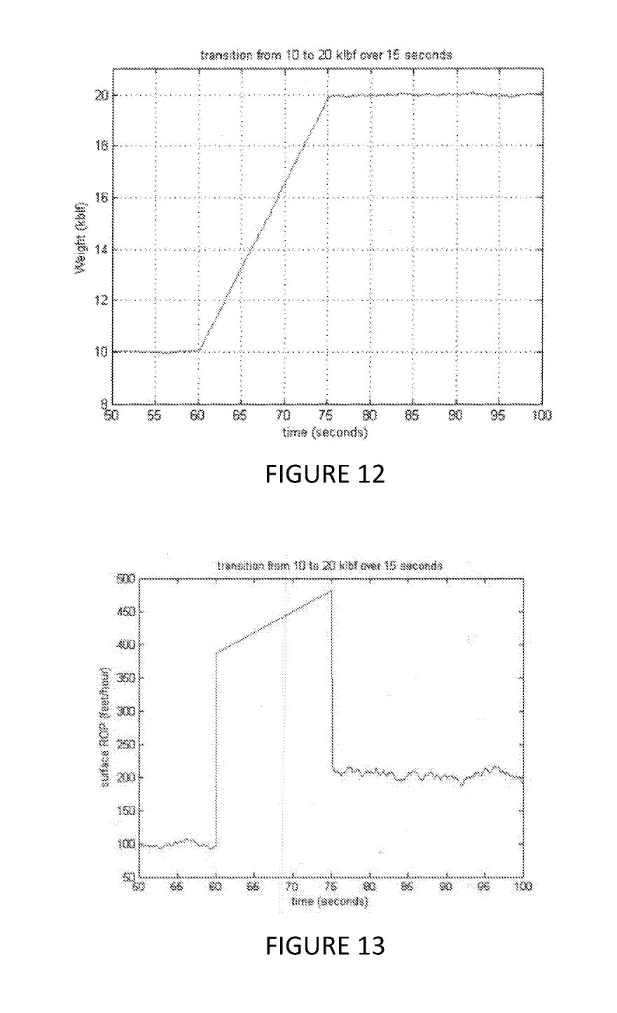

FIGS. 12 and 13 show the same transition with a ramp according to the invention. FIG. 12 shows weight change over 15 second transition—according to the invention. FIG. 13 shows surface ROP change over a 15 second ramp—according to the invention.

Various aspects of the invention relate to providing a methodology/framework to implement rotational vibration control. First, a slip-stick energy optimization algorithm may be deployed in Level 1 (Bottom) devices, i.e., PLCs for direct control. Second, a slip-stick energy optimization algorithm may be deployed as a software program in a high performance real time operating environment in Level 2 (Middle) coordinated computers, such as domain controllers. Third, rotational vibration control may be implemented through the use of a slip-stick energy optimization algorithm deployed anywhere in a control system.

A slip-stick energy optimization algorithm may be used to control a driver (top drive or rotary table) to reduce stick-slip in a drill rig system for drilling a wellbore. Rotational waves travel up and down the drillstring as the drillstring is rotated in the wellbore. Upgoing rotational waves may be reflected at the surface into downgoing rotational waves, which may lead to large rotational resonances and repetitive stick-slip. In a drillstring with larger pipe near the surface, some of the upgoing rotational waves may be reflected before they reach the surface, which may make surface control of stick-slip even more difficult because the waves are not observable at the surface. The downgoing rotational waves in the drillstring may also include those initiated by the driver (top drive or rotary table) as the driver rotates the drill string. One aspect of the invention seeks to achieve a desired drill string rotation speed at the surface (v₀) while minimizing the amount of downgoing energy (v_{down}). This formulation fits well as an outer control system driving a fast, built-in control system for the driver which is attempting to achieve a particular rotation speed. Modern PI top drive controllers (combined with high power top drives) can maintain very tight control over rotation speed. The slip-stick energy optimization algorithm control system of the present invention reduces or dampens torsional drill string vibrations, in particular slip-stick oscillations and torsional drill string resonances.

The approach of the present invention allows the rotational oscillations of suspended tubulars to be controlled. In this way, the rotational motion of a drillstring can be stabilized, but the approach could equally well be applied to tubulars used for completing a well, such as casing or running in a liner or completion. Both the parameters/conditions desirable for optimal/desired drilling operation of the drilling system and the parameters/conditions for preventing/mitigating stick-slip can be processed/controlled during the drilling operation.

In the drillstring during the drilling of the borehole there are rotational waves going up and down the drillstring. The reflections of the upgoing waves into downgoing waves at the surface produce the large rotational resonances in, and repetitive stick-slip motion of, the drilling system.

The downgoing waves in the drillstring also include those initiated by the system driving the drillstring, i.e. the top drive or the rotary table. These downgoing waves in the drillstring produced by the driver or drive system are required in order to drive the drill bit to drill through the earth formation. As such, the downgoing energy comprises desirable downgoing energy that is used to drive the drill bit and undesirable downward energy that causes oscillation in the drillstring and/or stick slip. Consequently, systems and methods can be provided which aim to achieve a desired rotation speed of the drillstring (hereinafter referred to as v₀) while minimizing the amount of energy contained in the downgoing rotation (the downgoing rotation is hereinafter referred to as v_{down}).

Thus in general, a processor may determine an optimized speed of rotation for the drillstring, wherein the optimized speed of rotation balances/optimizes delivery of rotational energy to the drill bit against reduction of energy travelling down the drillstring. More particularly, the control unit can provide an outer control system used to control a fast, built-in control system for the driver (top drive or rotary table; wherein a desired/determined rotation speed is provided to the built-in control system, which attempts to achieve the particular rotation speed, and the outer control system controls the driver (top drive or rotary table) to vary the rotation speed around the desired/determined rotation speed to reduce the amount of downgoing energy.

The contrary objectives of maximizing energy sent down the drillstring to the drill bit by rotating the drillstring and minimizing downgoing energy to prevent large oscillations of the drillstring in the borehole and/or stick-slip may be viewed as a minimization constraint that can be written as minimizing E such that:

$$E = {( v - {v}_{0} )}^{2} + λ {v}_{down}^{2} = {( v - {v}_{0} )}^{2} + {λ ( v - {v}_{up} )}^{2} \qquad ( 20 )$$

where:
v₀ is the desired average rotation speed;
v is the determined rotation speed to be fed to the top-drive and is the sum of vᵤₚ and v_{down}; and
λ is a constant that reflects a relative weight given to the two conflicting objectives.

Equation (20) can be embodied in an algorithm which determines a rotation speed v that is then passed to the top-drive controller, on the assumption that the controller is able to exactly achieve that speed. While modem top-drive controllers are normally able to achieve close to a commanded speed, there will inevitably be small differences between actual and the commanded speeds. Such small differences do not invalidate the control algorithm.

Thus, when v appears on the left-hand-side of an equation it should be interpreted as the commanded rotation speed to be sent to the top-drive controller. When it appears on the right-hand-side of an equation, it is preferably the most recent actual measured rotation speed of the top-drive, although if this is not available, the most recent previous commanded rotation speed can be substituted.

The upgoing component of the rotation speed may be estimated from simultaneous surface measurements of the rotation speed and torque in the drillstring (T). A rotational impedance of the pipe z may be determined, i.e., from pipe dimension or the like at the surface. The downgoing and upgoing components of the rotation may then be given by:

$${v}_{down} = \frac{1}{2} ( v + \frac{T}{z} )$$

$${v}_{up} = \frac{1}{2} ( v - \frac{T}{z} )$$

where z is the pipe impedance.

The corresponding upgoing and downgoing energies are proportional to v²_{down} and v²ᵤₚ and their sum is proportional to the total rotational energy of the drillstring:

$${v}_{up}^{2} + {v}_{down}^{2} = \frac{1}{2} {v}^{2} + \frac{1}{2 {z}^{2}} {T}^{2}$$

Although it is desirable for the correct value of z to be used, the controller is generally robust to errors in the value of z.

The solution to equation (1) is given by:

$$v = \frac{{v}_{0} + λ {v}_{up}}{1 + λ}$$

However, this solution provides a slower mean rotation speed for the drillstring than is desirable, i.e., the rotation speed reduces downgoing energy and thus reduces oscillation of the drillstring, but the downgoing energy is so low it produces slow rotation of the drill bit and undesirable drilling speeds. Accordingly, the minimization constraint can be rewritten as:

E=(v−(1+λ)v₀)²+λv_{down}²

A solution of this minimization constraint is:

$$v = {v}_{0} + \frac{λ}{1 + λ} {v}_{up}$$

The term vᵤₚ on the right hand side is calculated from the most recent measurements of torque and rotation speed, and thus there is a slight lag. In some embodiments of the present disclosure, this lag is configured to be less than at least one quarter of the period of the dominant resonance of the rotation system.

In some embodiments of the present disclosure, a residual correction term Γ may be included in the solution to account for the long term average of the rotation speed. This then provides the following solution for the minimization constraint, where t is the current time and δ is the sampling interval:

$$v ( t ) = r ( t ) + {v}_{0} ( t ) + \frac{λ}{1 + λ} {v}_{up} ( t - δ ) \qquad ( 21 )$$

the rate of change of the residual correction being proportional to the difference between the current and desired average rotation speed, as follows:

$$\frac{dr}{dt} = \frac{1}{k} ( v - {v}_{0} )$$

and k being chosen so that it is long compared to the resonance time of the system. For example, k may be of the order of 60 seconds or longer. Optionally, it is possible to independently control the feedback on torque vs. the feedback on the speed via a modification of equation (2) to provide a more general formulation as follows.

$$v ( t ) = {v}_{0} ( t ) + r ( t ) + {k}_{1} v - {k}_{2} \frac{T}{z}$$

In discrete time, with sampling interval 6, r may be calculated by:

$${r}_{j} = {r}_{j - 1} + \frac{δ}{k} ( {v}_{j} - {v}_{0 ( j )} )$$

A high-pass filter may be applied to the signal vᵤₚ used in equation (21). This may be done using a one-pole filter, with the same value of k, where:

$${v}_{{up}_{j}}^{l} = ( 1 - \frac{δ}{k} ) {v}_{{up}_{j - 1}}^{l} + \frac{δ}{k} {v}_{{up}_{j}}$$

$${v}_{{up}_{j}}^{h} = {v}_{{up}_{j}} - {v}_{{up}_{j}}^{l}$$

and where the subscript j indicates the time step, the superscript l indicates the filtered-out low-pass signal, and the superscript h indicates the remaining high-pass signal. The value of λ used in equation (21) may be 1. The λ parameter controls how much reduction in rotational resonance is to be provided by the control system. For example, when λ is set to zero, the control system will provide zero reduction in torsional resonance. The desired torsional resonance control may be selected and this selection may be weighed against other desired drilling parameters.

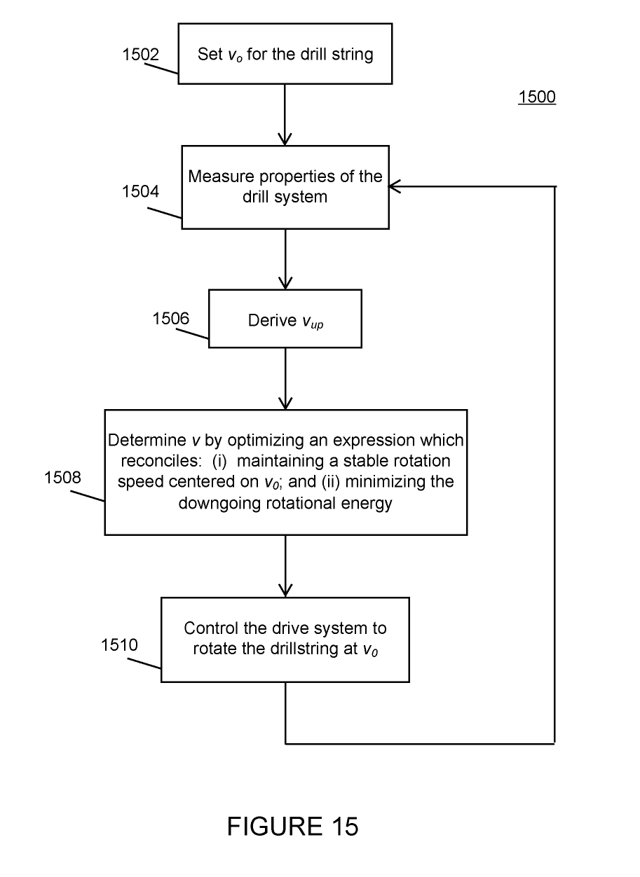

FIG. 15 shows a basic flow diagram for a slip-stick algorithm in accordance with an embodiment of the present disclosure that implements control based on equation (21). In some embodiments of the present disclosure, after v₀ is set in step 1502, the algorithm loops around the subsequent steps at a repeat interval that is sufficiently short that the steps are repeated multiple times during the dominant rotational resonance of the system. The properties of the drilling system are measured at step 1504. At step 1506, vᵤₚ is derived. At step 1508, v is determined by optimizing an expression which reconciles: (i) maintaining a stable rotation speed centered on v₀, and (ii) minimizing the downgoing rotational energy. The drive system is controlled to rotate the drillstring at v₀, at step 1510.

When the system is activated, the value of λ may vary over time such that initially it is zero or close to zero, and subsequently increases until it reaches a chosen value. In some embodiments of the present disclosure, this method of gradual activation reduces the variation in system behavior seen in the drilling system.

If the high-pass filter is applied to the upgoing rotation speed vᵤₚ, then theoretically, no residual correction term r is required. However, some embodiments, such a correction term may still be used to avoid drift from noise or calculation error.

In some embodiments of the present disclosure, in order to avoid sending high-frequency noise to the drive system (i.e. the driver controller or the like) that may interact with the internal control algorithm, the estimate of the upgoing rotation speed may be low-pass filtered. This can be done in the same way as for r, but with a smaller value of k, which can be chosen so that it does not filter out the main rotational resonance of the drillstring. A value for k may, in some embodiments of the present disclosure, be of the order of 0.1 s. A low-pass one-pole filter can be provided according to:

$${v}_{{up}_{j}}^{f} = ( 1 - \frac{δ}{k} ) {v}_{{up}_{j - 1}}^{f} + \frac{δ}{k} {v}_{{up}_{j}}$$

where the superscript f indicates the filtered signal.

In a drilling system, if the bit sticks hard, it is possible for the drillstring rotation to stop completely. To avoid this, in some embodiments of the present disclosure, a minimum value of v may be imposed. For example, a minimum value of v may be imposed on the control system that is 25% or 50% less than the desired average value v₀. It may also be desirable, for reasons such as reducing vibration on the rig, or limitations of the top drive gearbox, for there to be an upper limit on the rotation speed. In a similar manner, in some embodiments of the present disclosure, a maximum value of v may be imposed on the system.

Equation (21) may be rewritten as:

$${v}_{j} = {r}_{j} + {v}_{0 ( j )} + \frac{λ}{1 + λ} {v}_{{up}_{j - 1}}^{f}$$

As noted above, in some embodiments of the present disclosure, the slip-stick energy optimization algorithm may be processed in a processor for desired drilling speeds and the speed of rotation of the drillstring may be controlled in accordance with the output of the slip-stick energy optimization algorithm.

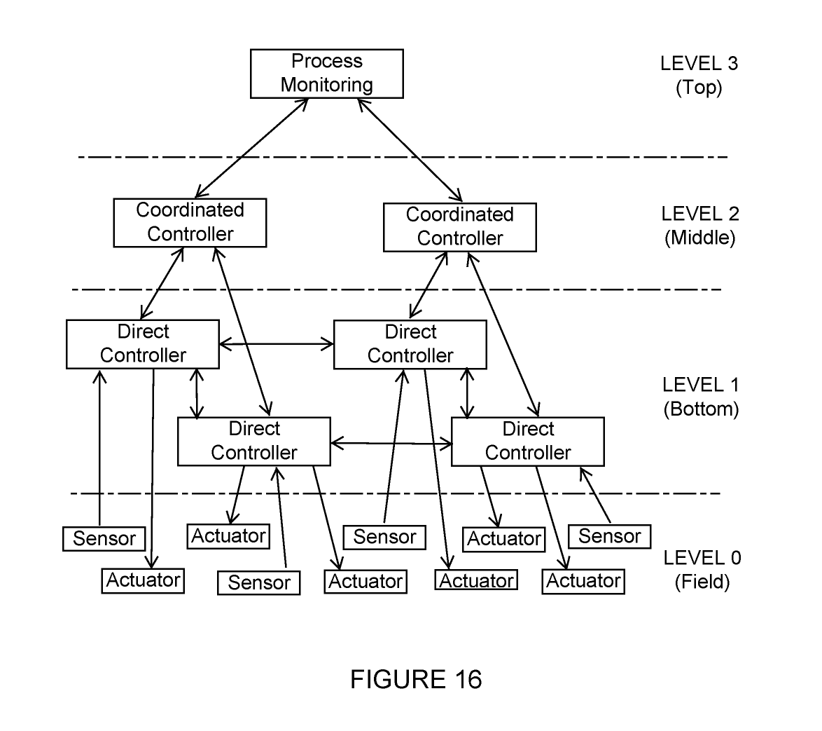

Referring to FIG. 16, control levels are illustrated for a drilling rig control system. A significant difference between each of the levels consideration for how software programs or algorithms are programmed into the hardware and the configurability or editability of the software once programmed into the hardware. A further distinction between the levels is the speed of the communications between devices at the control level.

Level 0 (Field) comprises sensors and actuators for a variety of drilling subsystems. Example subsystems include a drilling fluid circulation system (which may include mud pumps, valves, fluid reconditioning equipment, etc.), a rig control system (which may include hoisting equipment, drillstring rotary mover equipment (such as a top drive and/or rotary table), a PHM, a catwalk, etc.), a managed pressure drilling system, a cementing system, a rig walk system, etc. Level 0 (Field) may comprise a high speed controller, such as a variable frequency drive (VFD). Level 0 (Field) hardware devices may be programmed with software by the manufacturer and the software may be less suitable for modification unless performed by the manufacturer.

Level 1 (Bottom) comprises direct control devices for directly controlling the Level 0 (Field) subsystems. Level 1 (Bottom) direct controllers can include programmable logic controllers (PLCs), processors, industrial computers, personal computer based controllers, soft PLCs, the like, and/or any example controller configured and operable to receive sensor data from subsystem sensors and/or transmit control instructions to subsystem equipment. Level 1 (Bottom) processors may be, comprise, or be implemented by one or more processors of various types operable in the local application environment, and may include one or more general purpose processors, special-purpose processors, microprocessors, digital signal processors (DSPs), field-programmable gate arrays (FPGAs), application-specific integrated circuits (ASICs), processors based on a multi-core processor architecture, and/or other processors. More particularly, examples of a processor include one or more INTEL microprocessors, microcontrollers from the ARM and/or PICO families of microcontrollers, embedded soft/hard processors in one or more FPGAs, etc. Sensors and various other components may transmit sensor data and/or status data to a direct controller, and controllable components may receive commands from a direct controller to control operations of the controllable components. One or more aspects disclosed herein may allow communication between direct controllers of different subsystems through virtual networks. Sensor data and/or status data may be communicated through virtual networks and a common data bus between direct controllers of different subsystems. Level 1 (Bottom) direct controllers may be programmed and deployed, but with relative difficulty. Programmed software may thereafter be configured and edited, but with relative difficulty. Only very rigid computer programing is possible. A field bus is used to communicate with Level 1 (Bottom) direct controllers via protocols, such as Ethernet CAT, ProfiNET, ProfiBus, Modbus, etc.

Level 2 (Middle) comprises coordinated control devices. These include a variety of computing devices, for example, computers, such as industrial PC, processors, domain controllers, programmable logic controllers (PLCs), industrial computers, personal computers based controllers, soft PLCs, the like, and/or any example controller configured and operable to receive information and data available on a Level 2 network, and transmit control commands and instructions to direct controllers at Level 1, which directly control subsystem equipment. Level 2 (Middle) processors may be, comprise, or be implemented by one or more processors of various types operable in the local application environment, and may include one or more general purpose processors, special-purpose processors, microprocessors, digital signal processors (DSPs), field-programmable gate arrays (FPGAs), application-specific integrated circuits (ASICs), processors based on a multi-core processor architecture, and/or other processors. More particularly, examples of a processor include one or more INTEL microprocessors, microcontrollers from the ARM and/or PICO families of microcontrollers, embedded soft/hard processors in one or more FPGAs, etc. Level 2 (Middle) coordinated controllers may be programmed and deployed relatively easily as high level programming languages, such as C/C++, may be used with software program running in a real time operating system (RTOS). A real time communication databus is used to communicate with Level 2 (Middle) coordinated controllers via protocols, such as TCP/IP and UDP.

Level 3 (Top) comprises process monitoring devices that do not control, but merely monitor activity and provide information to the controlling devices at lower levels. Any computing device known to persons of skill in the art may perform Level 3 functions.

A control system implementing the slip-stick energy optimization algorithm may either be implemented in PLC at Level 1 (Bottom), or in an industrial PC running a real time operating system at Level 2 (Middle), or in a server computer or a virtual machine at any level.

Systems and methods and/or processes according to one or more aspects of the present disclosure may be used or performed in connection with well construction at a well site, such as construction of a wellbore to obtain hydrocarbons (e.g., oil and/or gas) from a formation, including drilling the wellbore. For example, some aspects may be described in the context of drilling a wellbore in the oil and gas industry. One or more aspects of the present disclosure may be used in other systems. Various subsystems used in constructing the well site may have sensors and/or controllable components that are communicatively coupled to one or more direct controllers at Level 1 (Bottom).

Additionally, a coordinated controller at Level 2 (Middle) can implement control logic to issue commands to various ones of the direct controllers through the virtual networks and common data bus to thereby control operations of one or more controllable components. A person having ordinary skill in the art will readily understand that one or more aspects of systems and methods and/or processes disclosed herein may be used in other contexts, including other systems.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

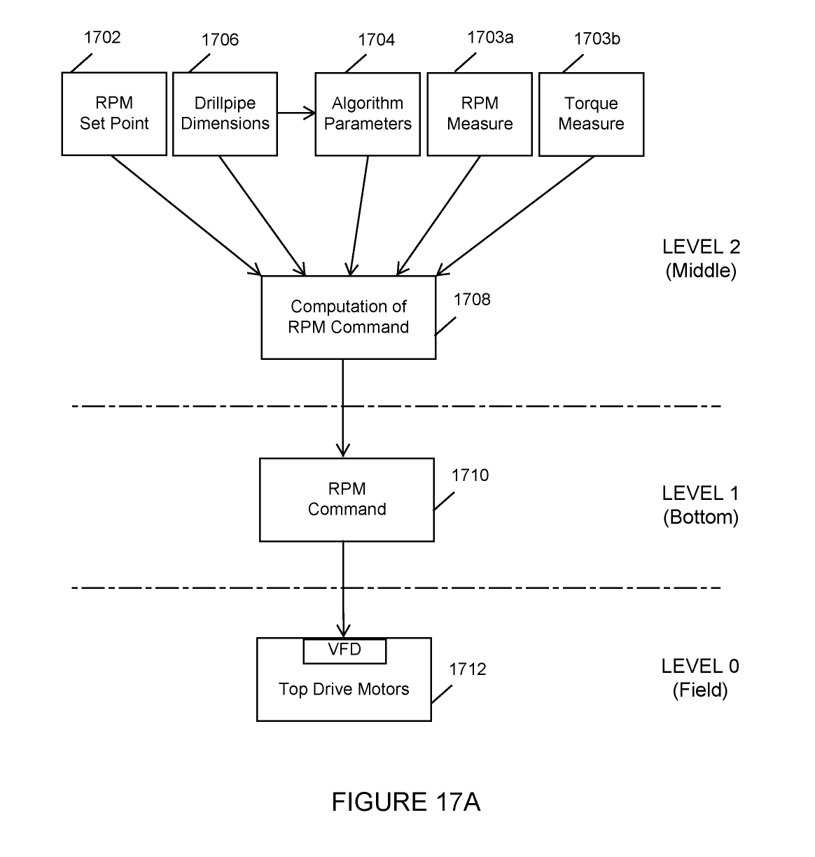

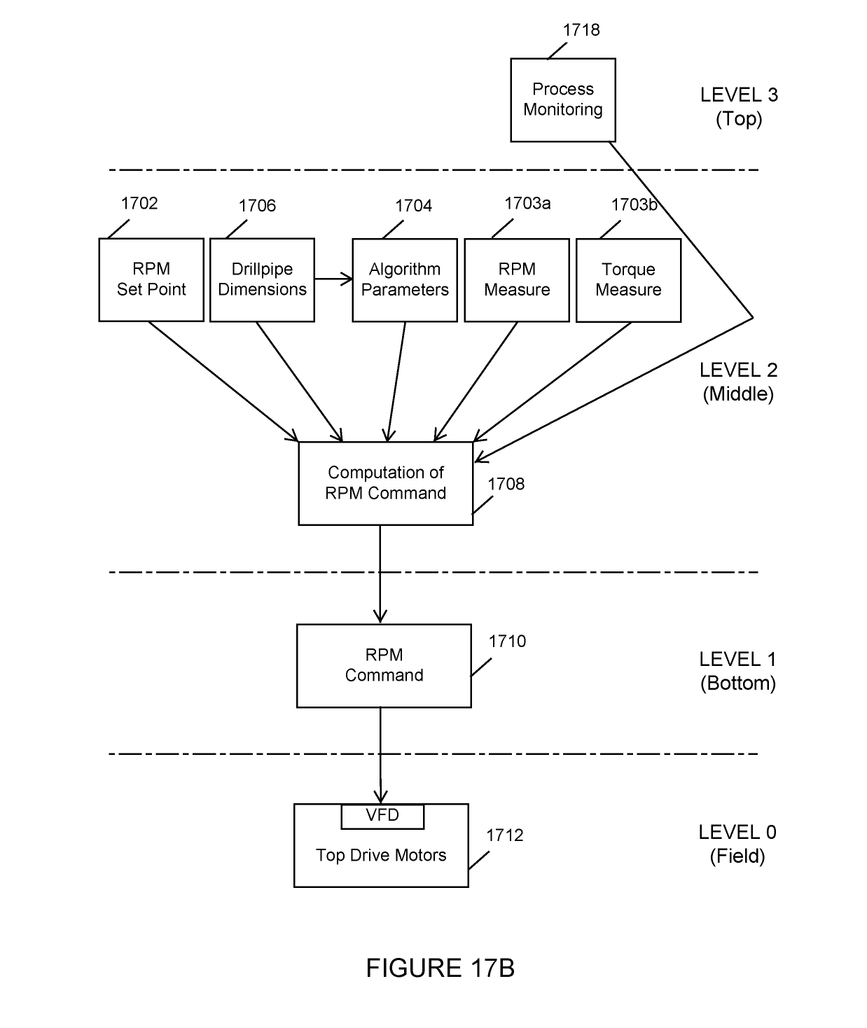

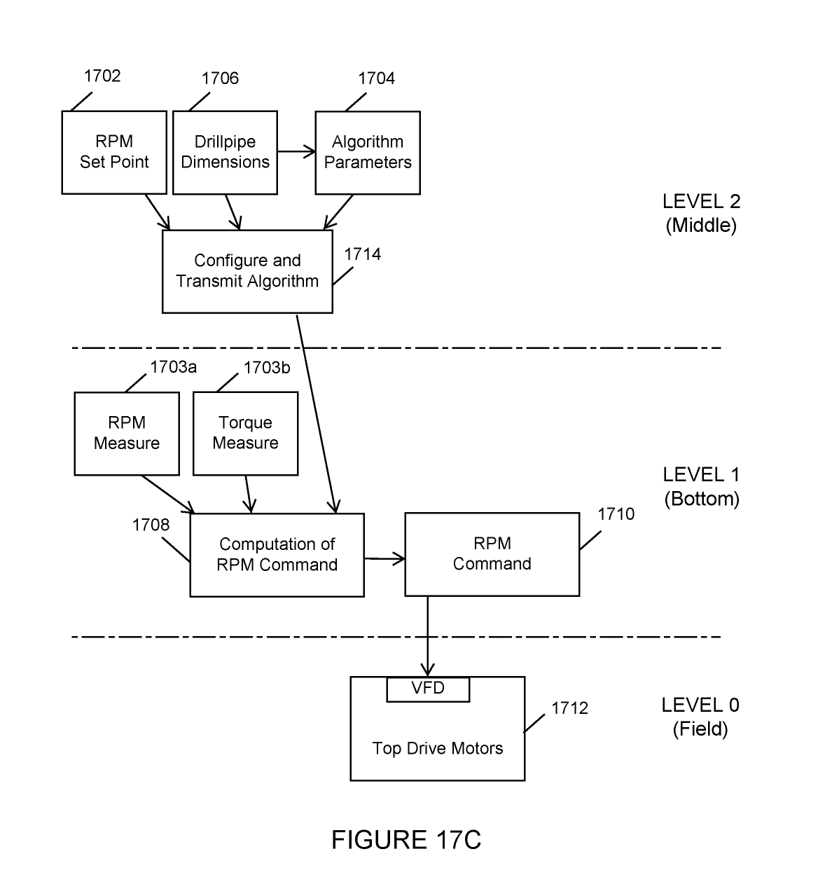

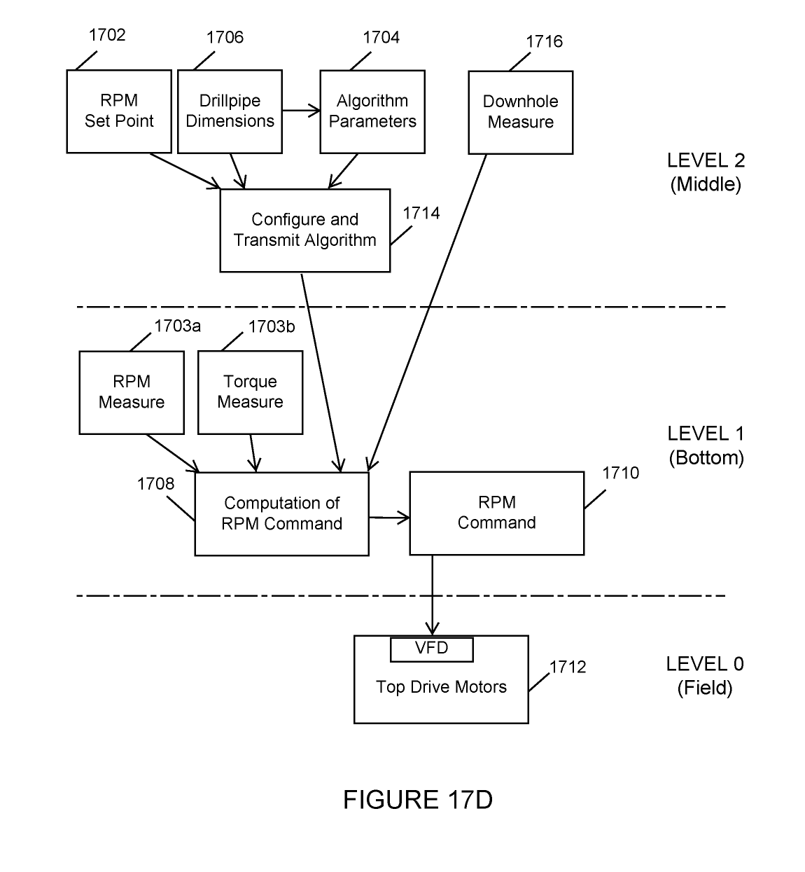

FIG. 17A illustrates a flow chart for controlling the speed of rotation of the drillstring with the output of the slip-stick energy optimization algorithm implemented in Level 2 (Middle). Set points for rotations per minute RPM may be set at step 1702. Algorithm parameters may be set at step 1704. Drillpipe dimensions may be input 1706 into the algorithm parameters. Measurements for rotation velocity RPM may be taken or recorded at step 1703a and measurements for torque may be taken or recorded at step 1703b. The set points, algorithm parameters and measurements may be used to compute a rotation velocity RPM command at step 1708. A rotation velocity RPM command is communicated from a PC at Level 2 (Middle) to a PLC at Level 1 (Bottom) at step 1710. The PLC commands 1712 the top drive motors to turn the drill string at the computed RPM, wherein the top drive motors are at Level 0 (Field). Steps 1702 and 1704 may be low frequency information (seconds-minutes). Steps 1703, 1708 and 1710 may be higher frequency information (˜10-200 hz). Further, the measurements taken or recorded at steps 1703a and 1703b may be passed from sensors up to the PC software Level 2 (Middle). The computation of the rotational velocity command at step 1708 may be done at the PC software Level 2 (Middle). The rotational velocity command may be sent at step 1710 from the PC software at Level 2 (Middle) to the PLC at Level 1 (Bottom), which command may include proportional and integral gain values to be used in the RPM P-I control. The algorithm parameters may include: K for r(t) term evolution; λ (typically 1); minimum RPM; filter for vᵤₚ; and impedance. Control of the rotation speed of the top drive may be solely in response to velocity and torque waves traveling up the drillstring. This rotation speed command may be either greater than or less than the desired top drive rotation speed.

FIG. 17B illustrates a flow chart for controlling the speed of rotation of the drillstring with the output of the slip-stick energy optimization algorithm implemented in Level 2 (Middle), with the added feature that job-type data is input. Job Planner and/or an operation monitoring data may be collected by a Level 3 (Top) process monitoring computer at step 1718. The job planner and/or operation monitoring computer may gather information from offset wells, job planning or operation sequence for the ongoing job, drilling information, including drill string, BHA, and equipment. The other steps are the same is illustrated in FIG. 17A.

FIG. 17C illustrates a flow chart for controlling the speed of rotation of the drillstring with the output of the slip-stick energy optimization algorithm implemented in Level 1 (Bottom). Set points for rotations per minute RPM may be set at step 1702. Algorithm parameters may be set at step 1704. Drillpipe dimensions may be input 1706 into the algorithm parameters. Based upon these inputs, the slip-stick energy optimization algorithm is configured and transmitted from a coordinated controller at Level 2 (Middle) to a top drive direct controller at Level 1 (Bottom). Measurements for rotation velocity RPM and torque may be taken or recorded at steps 1703a and 1703b via Level 1 (Bottom) direct controllers and communicated to a top drive Level 1 (Bottom) direct controller. The top drive Level 1 (Bottom) direct controller computes an RPM command with the slip-stick energy optimization algorithm at step 1708 and communicates the RPM command at step 1710 to the Level 0 (Field) top drive motors, which rotate the drill string at the commanded speed at step 1712. The set points, algorithm parameters and measurements may be used to compute a rotation velocity RPM command at step 1708. Steps 1702 and 1704 may be low frequency information (seconds-minutes). Steps 1703, 1708 and 1710 may be higher frequency information (˜10-200 hz). Further, the measurements taken or recorded at steps 1703a and 1703b may be passed from sensors up to PLCs in Level 1 (Bottom). The computation of the rotational velocity command at step 1708 may be done by a PLC in Level 1 (Bottom). The rotational velocity command may include proportional and integral gain values to be used in the RPM P-I control. The algorithm parameters may include: K for r(t) term evolution; λ (typically 1); minimum RPM; filter for vᵤₚ; and impedance. Control of the rotation speed of the top drive may be solely in response to velocity and torque waves traveling up the drillstring. This rotation speed command may be either greater than or less than the desired top drive rotation speed.

In an alternative embodiment, Job Planner and/or an operation monitoring data may be collected by a Level 3 (Top) process monitoring computer as described with reference to FIG. 17B and added as an input to the algorithm implemented in Level 1 (Bottom) as described with reference to FIG. 17C.

FIG. 17D illustrates a flow chart for controlling the speed of rotation of the drillstring with the output of the slip-stick energy optimization algorithm implemented in Level 1 (Bottom), with the added feature that downhole measurement data is input to the algorithm. While the RPM and Torque measurements 1703a and 1703b are taken via sensors of the drill string at the surface, downhole measurements are taken from sensors in a bottom hole assembly or other components in the drill string located downhole. Downhole data may be transmitted to a Level 2 (Middle) coordination controller the surface. The downhole data is then transmitted from the Level 2 (Middle) coordination controller to the Level 1 (Bottom) direct controller of the top drive at step 1716. The other steps are the same as in FIG. 17C. In this embodiment, a level 2 coordinate controller may not be needed, or communication frequency at between Level 2 and Level 1 may not needed to be as high as shown above.

In an alternative embodiment, downhole data may be transmitted to a Level 2 (Middle) coordination controller the surface as described with reference to FIG. 17D and added as an input to the algorithm implemented in Level 2 (Middle) as described with reference to FIG. 17A.

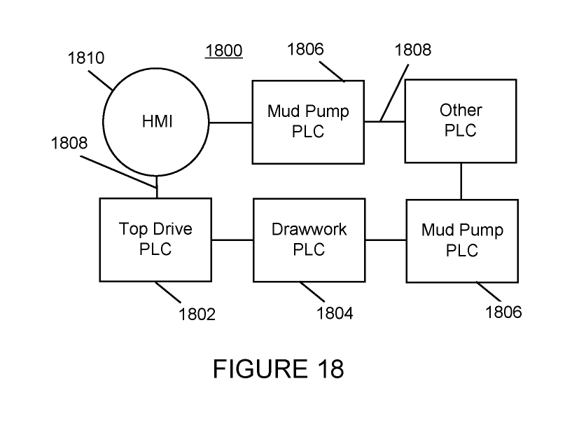

FIG. 18 shows a drill rig subsystem control 400 containing a number of PLCs. PLC 1802 may control a top drive, PLC 1804 may control the drawwork, and PLC 406 may control mud pump, etc. It is possible for one PLC to control more than one equipment. For example, a PLC may control both the top drive and the drawwork. The PLCs are considered Level 1 (Bottom) controls. A human machine interface (HMI) 1810 may be attached to the network 1808, and is used as a human machine interface for the operator to interact with the equipment (turn on/off, adjust set point, etc). A field bus communication network 1808 is established among all these PLCs and the RCS HMI. The field bus protocols may be those protocols for industrial network systems used for real time distributed controls, as standardized in IEC 61158 or other Ethernet based real time communication protocols. Examples of fieldbus communication protocols include Modbus, Modbus TCP, ProfiBus, ProfiNet, EtherNet/IP, Ethernet PowerLink, etc. A ring topology is illustrated, but alternative embodiments can have any network topology, such as a bus topology, a star topology, mesh topology, etc. Furthermore, a Historian (not shown) may be provided to record key parameters communicated in the fieldbus 1808.

Referring to FIG. 18, in an alternative embodiment of the invention, the slip-stick energy optimization algorithm may be implemented within the Top Drive PLC 1802 for direct control, which would be considered a Level 1 (Bottom) implementation. User input of parameters, such as RPM set point, drilling dimension information and algorithm parameters may be used to configure the algorithm via the human machine interface (HMI) 1810, and then the configured algorithm is passed via the communication network 1808 to the top drive PLC 1802. According to this embodiment, RPM commands may be communicated to the top dive motors via the process shown in FIG. 17B.

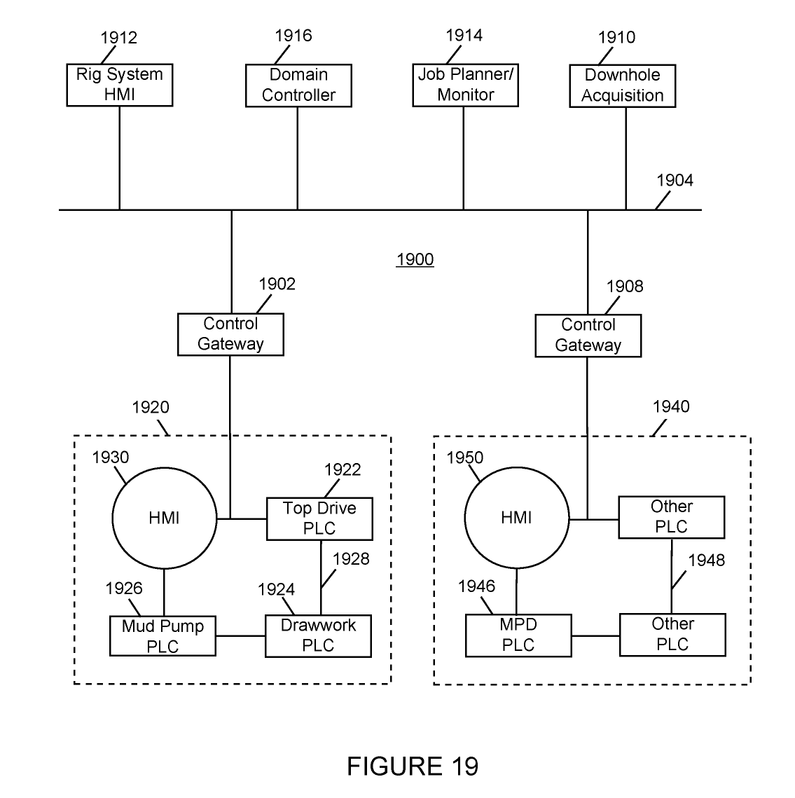

FIG. 19 illustrates an alternative embodiment of drill rig control system 1900. A drill rig subsystem control 1920 is similar to that shown in FIG. 18, wherein it has a human machine interface (HMI) 1930, a top drive PLC 1922, a drawwork PLC 1924, and a mud pump PLC 1926, all connected via a field bus 1928. As described above, the PLCs are Level 1 (Bottom) direct controllers. A control gateway 1902 is provided to encapsulate the drill rig subsystem control 1920, and to expose the RCS sensors and commands to a real time communication databus 1904. Communications on the real time communication databus 1904 may be via protocols, such as TCP/IP and UDP. Other systems on the rig may be encapsulated in a similar way. As an example, a managed pressure drilling subsystem (MPD) 1940 is encapsulated through a gateway 1908, and exposed to the communication databus 1904. The MPD subsystem 1940 may comprise a MPD PLC 1946 and an HMI 1950, as well as other PLCs. A downhole acquisition system 1910 may be exposed to the real time databus 1904 as well.

A number applications may be connected to the real time communication databus 1904. For example, a rig system HMI 1912 may be provided to control all subsystems, including HMI 1930 and HMI 1950, that are connected to the communication databus 1904 through the Control Gateways 1902 and 1908. A Job Planner and/or an operation monitoring application 1914 may be connected to the same databus 1904. The job planner and/or operation monitoring application 1914 may contain information from offset wells, job planning or operation sequence for the ongoing job, drilling information, including drill string, BHA, and equipment. Job Planner/Monitor 1914 may be considered a Level 3 (Top) controller or computer. (See FIG. 16).

One or a plurality of domain controllers 1916, which are Level 2 (Middle) coordinated computers, may be connected to the communication databus 1904. The domain controller 1916 may receive information from the communication databus 1904, which could include command from the Rig System HMI 1912, Job Planner/Monitor application 1914, and downhole acquisition 1910. The domain controllers 1916 may issue commands to the equipment of different subsystems, such as the top drive via top drive PLC 1922 and HMI 1930, or the choke via the MPD PLC 1946 and HMI 1950. The domain controllers 1916 may contain arbitration mechanism to prevent more than one controller to control the same equipment at the same time.

Referring again to FIG. 19, in one embodiment of the invention, the slip-stick energy optimization algorithm may be implemented in Level 2 (Middle). In particular, the algorithm may be implemented in the domain controller 1916. According to this embodiment, RPM commands may be communicated to the top dive motors via the process shown in FIG. 17A.

Referring to FIG. 19, in an alternative embodiment of the invention, the slip-stick energy optimization algorithm may be implemented within the Top Drive PLC 1922 for direct control, which would be considered a Level 1 (Bottom) implementation. User input of parameters, such as RPM set point, drilling dimension information and algorithm parameters may be used to configure the algorithm via the domain controller 1916, and then the configured algorithm is passed via the databus 1904 and field bus 1928 to the top drive PLC 1922. According to this embodiment, RPM commands may be communicated to the top dive motors via the process shown in FIG. 17B.

By implementing the slip-stick energy optimization algorithm in a domain controller 1916 at Level 2 (Middle), one may be able to better control the downhole oscillation of drillstring:
1. With access to offset well data, the domain controller may be automated to start in the zones where downhole oscillation is most severe.
2. With access to the downhole acquisition data, the domain controller may use the downhole vibration data as a feedback to tune the control parameters to accomplish better oscillation control
3. With access to job planning data, the domain controller may be automated to start and stop at the appropriate time during drilling operation.

According to alternative embodiments of the invention, the domain controller 1916 may receive information from the communication databus 1904, which could include command from the Rig System HMI 1912, Job Planner/Monitor application 1914, and downhole acquisition 1910. Based on these and any other relevant inputs, the domain controller 1916 may issue an RPM commands to the top drive via top drive PLC 1922 and outputs to HMI 1930. The downhole data may be used as feedback to tune the control parameters. Alternatively, if the downhole information is not available, the overall amplitude of surface torque fluctuations may be used in a similar way (both of these methods would need to be done over a much longer time-scale than the typical stick-slip timescale—about 10 s of seconds). In particular, the system may: a) note the level of surface torque fluctuations, b) turn on the algorithm with an initial set of control parameters, c) measure the new level of surface torque fluctuations, d) modify the control parameters, e) note the new level of surface torque fluctuations . . . etc, with the aim to minimize the surface torque fluctuations by optimizing these control parameters. If the downhole data is available, downhole RPM fluctuations may be used instead of the surface torque fluctuations.

According to a further embodiment of the invention, a coordinated controller implementing Level 2 (Middle) control may control drill string RPM via the slip-stick energy optimization algorithm in combination with any other known control algorithm.

According to still another embodiment of the invention, a direct controller implementing Level 1 (Bottom) control may control drill string RPM via the slip-stick energy optimization algorithm in combination with any other known control algorithm.

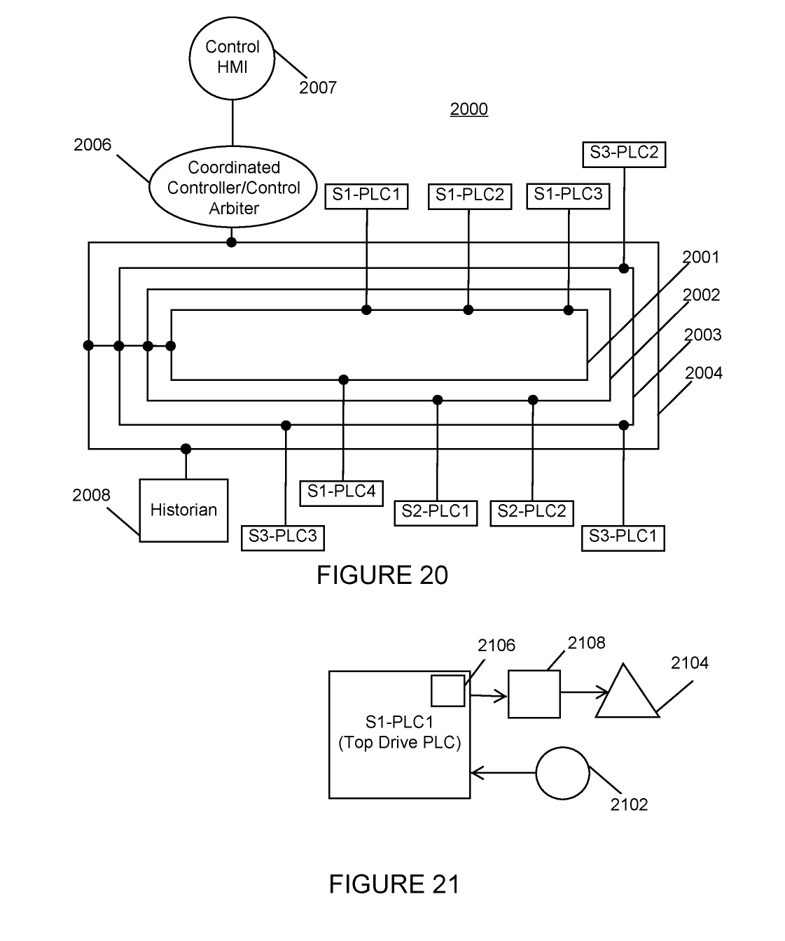

FIG. 20 illustrates a schematic diagram of a well construction control system 2000. For illustration purposes, three subsystems are integrated in this control system, wherein each subsystem contains its own VLAN and Level 1 (Bottom) direct controllers.
Subsystem S1: VLAN 2001 and four controllers (PLCs) in the system, S1-PLC1, SI-PLC2, S1-PLC3 and S1-PLC4.
Subsystem S2: VLAN 2002 and two PLCs in the system, S2-PLC 1 and S2-PLC2.
Subsystem S3: VLAN 2003 and three PLCs in the system, S3-PLC 1, S3-PLC2 and S3-PLC3.

A subsystem may include a single piece of equipment or may include multiple pieces of equipment, e.g., that are jointly used to perform one or more function. Each subsystem includes one or more PLCs, which may control equipment and/or receive sensor and/or status data from sensors and/or equipment. Any number of control subsystems may be implemented, and any number of PLCs may be used in any control subsystem. The well construction control system 2000 may use an Ethernet-based communication protocol. Each subsystem may maintain its own control philosophy, and run on its own virtual network. Virtual Network can be understood as implemented by IEEE 802.1Q. Each subsystem may use its own communication protocol compatible with Ethernet based network, such as ProfiNET, OPC, OPC/UA, Modbus TCP/IP, EtherCAT, UDP multicast, Siemens S7 communication, or the like), a proprietary communication protocol, and/or another communication protocol, etc. However, it is preferable for the subsystem to use a communication protocol that implements some form of publish/subscribe communications. The subsystem virtual networks can implement the same protocol, each subsystem virtual network can implement a different protocol, or any combination of protocols.

As shown in FIG. 20, there is a data communication network 2004 that uses VLAN Data to communicate sensor or status-based data, which are shared among different subsystems. This data communication network 2004 is accessible by all subsystems. A coordinated controller 2006, which is a Level 2 (Middle) coordinated controller, has access to all subsystems, including the data communication network 2004. Controllers in each subsystem may receive and execute control commands from other controllers in the same subsystem, as well as command from the coordinated controller 2006. However, controllers in one subsystem may not receive and/or execute commands from any controller in another subsystem. VLANs may segment network traffic for two main purposes. First, security, as inter-VLAN control traffic, is only possible through the coordinated controller 2006. Second, control network stability, as VLANs, restrict congestion from multicast or broadcast traffic to the subsystem at fault.

The coordinated controller is able to dynamically detect which systems and controllers are available on any subsystem by using IP multicast. If a new controller is connected to a given VLAN/subsystem, the coordinated controller can detect the controller and start issuing commands through the new controller's API. There may be no need to install a new gateway or disrupt the existing network infrastructure in order to utilize the new controller.

This control system may be secured further using standard off-the-shelf security devices. For example, an intrusion detection system (IDS) can be installed in each VLAN to monitor the traffic within its own network. Separately, a global IDS with access to all VLAN can be installed to monitor the whole system. On the other hand, to maintain the integrity of equipment, security policy can be implemented that allow only certain PLCs or controllers to issue commands to other PLCs or controllers.

Centralized access to the subsystems for e.g. software updates or online monitoring of PLC's is managed through a single interface at the same layer as the coordinated controller, thus avoiding the need to “punch holes” and expose the subsystems.

Communication among different VLANs in the system may be prioritized through network-based QoS as specified in IEEE 802.1q, and through the control applications. This allows low-latency data communication (such as machine control command) to receive real-time quality of service, while other less critical information (such as video data) is handled with lower priority. The coordinated controller 2006 may be a software program written in and compiled from a high-level programming language, such as C/C++ or the like. As described in further detail below, the coordinated controller 2006 may be operable to translate communications from various communications protocols to a common communication protocol and make the communications translated to the common communication protocol available through a common data bus, and vice versa. The common data bus may include an application program interface (API) of the coordinated controller 2006 and/or a common data virtual network (VN-DATA) implemented on one or more processing systems, such as network appliances like switches.

A unified Human-Machine Interface (HMI) 2007 may be provided to control the whole well construction system. This HMI can access each subsystem, and command its operation. A historian 2008 may be provided for the well construction system. The historian 2008 can access data in each VLAN. Hence when a new subsystem joins the well construction system, there is no need to add any new historian. By configuring the historian 2008 to receive data in the other VLANs, data from the newly joined subsystem may be collected in the historian 2008.

According to one embodiment of the invention, the oscillation algorithm described herein may be implemented in the coordinated Level 2 (Middle) coordinated controller 2006, as shown in FIG. 20. According to an alternative embodiment of the invention, the oscillation algorithm described herein may be implemented in one or more direct Level 1 (Bottom) PLCs, for example S1-PLC 1, as shown in FIG. 20.

FIG. 20 shows the overall control system topology with one or more human-machine interfaces HMI 2007. The HMI (Control HMI) 2007 provides the human-machine interface to operate all the rig equipment in the network (equipment on S1, S2 and S3 network, as shown). This HMI 2007 may directly interact with each individual subsystem network (e.g., S1). Alternatively, it may interact with the coordinated controller 2006 (or a control arbiter), which in turn control interacts with each individual subsystem PLCs to affect the control of the equipment. The coordinated controller 2006 (or control arbiter) may be implemented in a PLC. Alternatively, it may be implemented with an industrial PC running a real time operating system, or in a server computer or a virtual machine. Implementing coordinated controller (or control arbiter) in a machine other than PLC may be more advantageous as the machine will generally have more computing power to implement more complicated model based controllers. The HMI 2007 may comprise, or be implemented by, one or more processing systems with a keyboard, a mouse, a touchscreen, a joystick, one or more control switches or toggles, one or more buttons, a track-pad, a trackball, an image/code scanner, a voice recognition system, a display device (such as a liquid crystal display (LCD), a light-emitting diode (LED) display, and/or a cathode ray tube (CRT) display), a printer, speaker, and/or other examples. The HMI 2007 may allow for entry of commands to the coordinated controller 2006 and for visualization or other sensory perception of various data, such as sensor data, status data, and/or other example data. In some examples, an HMI may be a part of a control subsystem and can issue commands through a subsystem virtual network to one or more of the PLCs of that subsystem virtual network without using the coordinated controller 2006. Each HMI 2007 can be associated with and control a single or multiple subsystems. In a further example, an HMI can control an entirety of the system that includes each subsystem.

Security policy may be implemented to ensure that control system security. For example, a security may be imposed such that inter-network (VLAN) communication is not allowed unless such data exchange involved the coordinated controller (or control arbiter).

A control system historian 2008 may be provided to record sensory data, control commands, and machine status information for the whole control system. As shown in FIG. 20, the historian 2008 has read-access to each network (VLAN), which allows a plug-n-play recording of historian data as each subsystem (VLAN) is connect to the whole network. The historian 2008 may be a database maintained and operated on one or more processing systems, such as database devices, for example. The historian 2008 can be distributed across multiple processing systems and/or may be maintained in memory, which can include external storage, such as a hard disk or drive. The historian 2008 may access sensor data and/or status data, which is stored and maintained in the historian 2008.

FIG. 21 illustrates a schematic diagram of a top drive subsystem. S1-PLC 1 of FIG. 20 may be used to control the top drive subsystem, as shown in FIG. 21, and may connect to one or a plurality of sensors 2102. For example, one sensor may be used to measure the hookload, another sensor may be used to measure surface torque, yet another sensor may be used to measure the current applied to the top drive, yet another sensor may be used to measure the RPM, etc. The top drive PLC S1-PLC1 may connect to one or a plurality of actuators 2104. For example, one actuator 2104 may be the top drive motor; another actuator 2104 may be the position control of the elevator, etc. One or a plurality of control logic 2106 may be implemented in the PLC S1-PLC 1. This control logic 2106 may use the input from one or a plurality of sensors 2102 on the top drive PLC S1-PLC 1, and/or the sensors 2102 from other PLCs in the network, in conjunction with commands issued from the driller (via VLAN Si) to create a suitable machine control command to affect the operation of one or a plurality of actuators on the top drive PLC. According to an alternative embodiment of the invention, the oscillation algorithm described herein may be implemented in the direct Level 1 (Bottom) S1-PLC 1, as shown in FIGS. 20 and 21.

FIG. 21 further shows that an actuator 2104 of the top drive may be regulated by a variable frequency drive VFD 2108 that controls the current. According to an alternative embodiment of the invention, the oscillation algorithm described herein may be implemented in the Level 0 (Field) variable frequency drive VFD of the top drive motors.

Each PLC can implement logic to monitor and/or control one or more sensors and/or one or more controllable components of a respective subsystem. Each PLC can include logic to interpret a command and/or other data, such as from one or more sensors or controllable components, and to communicate a signal to one or more controllable components of the subsystem to control the one or more controllable components in response to the command and/or other data. Each PLC can also receive a signal from one or more sensors, can reformat the signal, such as from an analog signal to a digital signal, into interpretable data. The logic for each PLC can be programmable, such as compiled from a low level programming language, such as described in IEC 61131 programming languages for PLCs, structured text, ladder diagram, functional block diagrams, functional charts, or the like.

According to one embodiment of the invention, the domain controller 1916 (see FIG. 19) may be a coordinated controller that controls the top drive via top drive PLC 1922 or the like to control the rotation speed, wherein the drillstring is being driven in accordance with the output of the slip-stick energy optimization algorithm 1500 (see FIG. 15). In particular, a primary (e.g. built-in) control system 2106 (see FIG. 21) may directly control the top drive or the like to drive the drillstring at a desired speed of rotation and the domain controller 1916 may control the top drive or the like to drive the drillstring at rotation speeds around/proximal to the desired speed of rotation in accordance with the output of the slip-stick energy optimization algorithm 1500 (see FIG. 15). Use of such the domain controller 1916 means that existing control systems can be modified to implement control methods in accordance with the slip-stick energy optimization algorithm.

Although the disclosed embodiments are described in detail in the present disclosure, it should be understood that various changes, substitutions and alterations can be made to the embodiments without departing from their spirit and scope.

### INDUSTRIAL APPLICABILITY

Control systems and control algorithms for drilling rigs of the present invention have many industrial applications including but not limited to drilling well bores for the oil and gas industry.

What is claimed is:

1. A method for controlling a drilling system comprising a driver, drawworks, drillstring and drill bit, wherein the driver rotates the drillstring and the drawworks raises/lowers the drillstring during a drilling process to drill a borehole through an earth formation, comprising:
implementing a network comprising one or more controllers;
operating the one or more controllers, wherein the operating comprises:
receiving drill string status measurements from sensors associated with the drill string near the driver,
executing a control algorithm based on the received drill string status measurements to generate an actuator command; and
operating the driver based on the actuator command.

2. The method for controlling a drilling system of claim 1, wherein the actuator command is an RPM that the driver is commanded to achieve.

3. The method for controlling a drilling system of claim 1, wherein the actuator command is an axial speed that the drawworks is commanded to achieve.

4. The method for controlling a drilling system of claim 1, wherein the executing a control algorithm comprises executing a slip-stick energy optimization algorithm comprising:
setting a desired rotation speed v₀ for the drillstring;
deriving a component vᵤₚ of a rotation speed of the drillstring associated with upgoing rotational energy from the received drill string property measurements;
determining a rotation speed v for the drillstring by optimizing an expression which reconciles two conflicting objectives of: (i) maintaining a stable rotation speed centered on v₀, and (ii) minimizing downgoing rotational energy, the optimized expression expressing v in terms of v₀ and vᵤₚ; and
generating a RPM command for the driver to rotate the drillstring at v.

5. The method for controlling a drilling system of claim 4, wherein the receiving of status measurements, and deriving v and vᵤₚ therefrom; the determining of a next rotational speed v; and the controlling of the drive system are performed repeatedly.

6. The method for controlling a drilling system of claim 1, wherein the one or more controllers comprises a level 2 (middle) coordinated controller.

7. The method for controlling a drilling system of claim 6, wherein the implementing a network comprises facilitating network communications with the level 2 (middle) coordinated controller via a real time communication databus.

8. The method for controlling a drilling system of claim 1, wherein the one or more controllers comprises a level 1 (bottom) direct controller.

9. The method for controlling a drilling system of claim 8, wherein the implementing a network comprises facilitating network communications with the level 1 (bottom) direct controller via a field bus.

10. The method for controlling a drilling system of claim 1, wherein the implementing a network comprises facilitating network communications via a virtual network operable to implement an Ethernet-based communication protocol and/or publish-subscribe communications.

11. The method for controlling a drilling system of claim 1, wherein the one or more controllers comprises a level 0 (field) variable frequency drive.

12. The method for controlling a drilling system of claim 1, further comprising: operating a human-machine interface on one or more processing systems, wherein operating the human-machine interface comprises accessing data from the network.

13. The method for controlling a drilling system of claim 1, further comprising: transmitting to the one or more controllers data selected from at least one of: downhole vibration data, drilling equipment status data.

14. The method for controlling a drilling system of claim 1 further comprising: operating one or more level 3 process monitoring systems to collect and transmit to the one or more controllers data selected from at least one of: offset well data, job planning data, operation sequence data for the ongoing job, drill string data.

15. The method for controlling a drilling system of claim 1, wherein the executing a control algorithm comprises:
drilling a wellbore with a drilling system controlled by the autodriller under a first control parameter;
changing the first control parameter;
observing changes in the drilling system in response to the changed first control parameter;
combining data reflecting the observed changes in the drilling system;
estimating an exponential decay factor based on the combined data;
deriving second control parameter from the estimated decay factor; and
drilling the wellbore with the drilling system controlled by the autodriller under the second control parameter.

16. The method for controlling a drilling system of claim 15, wherein the first control parameter is rate of penetration.

17. The method for controlling a drilling system of claim 15, wherein the first control parameter is weight on bit.

18. The method for controlling a drilling system of claim 15, wherein the first control parameter is pressure.

19. The method for controlling a drilling system of claim 1, wherein the executing a control algorithm comprises: using drilling parameters to choose the ratio of the integral to proportional gains with proportional-integral control.

20. The method for controlling a drilling system of claim 1, wherein the executing a control algorithm comprises: using drilling parameters to choose the proportional gain with proportional-integral control.

21. The method for controlling a drilling system of claim 1, wherein the executing a control algorithm comprises:
drilling a wellbore with a drilling system controlled under a weight on bit control parameter;
operating feedback control to maintain a first value of weight on bit;
using feed-forward control to transition to a second value of weight on bit on a predetermined trajectory; and
operating feedback control to maintain weight on bit at a second value; and
drilling a wellbore with the system controlled under a weight on bit control parameter at the second value.

22. The method for controlling a drilling system of claim 21, wherein the feedback control method is proportional-integral control.

23. The method for controlling a drilling system of claim 1, wherein the executing a control algorithm comprises:
drilling a wellbore with a drilling system controlled under a pressure control parameter;
observing oscillations in the drilling system; and
increasing the integral gain time constant until oscillations are not observed in the drilling system.

24. The method for controlling a drilling system of claim 23, further comprising: for a given proportional gain, using estimated system parameters to choose a stable integral gain time constant.

25. The method for controlling a drilling system of claim 23, further comprising: choosing optimal proportional and integral gains, based on estimated system parameters.

26. The method for controlling a drilling system of claim 1, wherein the executing a control algorithm comprises:
drilling a wellbore with a drilling system controlled by the autodriller under a pressure control parameter;
change the set point pressure;
observing changes to the drilling system in response changed set point pressure;
estimating decay constants from the observed changes to the drilling system;
calculating a system parameter from the estimated decay constants, either alone or in combination with other estimates or calculations; and
drilling a wellbore with a drilling system controlled by the autodriller under a calculated system parameter.

27. A method for controlling a drilling system comprising a driver, drawworks, drillstring and drill bit, wherein the driver rotates the drillstring and the drawworks raises/lowers the drillstring during a drilling process to drill a borehole through an earth formation, the method comprising:
implementing controllers in a network comprising:
at least one level 0 (field) variable frequency drive of the driver;
at least one level 1 (bottom) direct controller, wherein the at least one level 0 (field) variable frequency drive and the at least one level 1 (bottom) direct controller communicate via a field bus;
at least one level 2 (middle) coordinated controller, wherein the at least one level 1 (bottom) direct controller and the at least one level 2 (middle) coordinated controller communicate via a real time databus;
operating one or more of the controllers, wherein the operating comprises:
receiving drill string status measurements from sensors associated with the drill string near the driver,
executing a slip-stick energy optimization algorithm based on the received drill string status measurements to generate a RPM command, comprising:
setting a desired rotation speed v₀ for the drillstring;
deriving a component vᵤₚ of a rotation speed of the drillstring associated with upgoing rotational energy from the received drill string status measurements;
determining a rotation speed v for the drillstring by optimizing an expression which reconciles two conflicting objectives of: (i) maintaining a stable rotation speed centered on v₀, and (ii) minimizing downgoing rotational energy, the optimized expression expressing v in terms of v₀ and vᵤₚ; and
generating a RPM command for the driver to rotate the drillstring at v; and
operating the driver based on the RPM command.

28. A method for controlling a drilling system as claimed in claim 27, wherein the operating one or more of the controllers comprises operating the at least one level 0 (field) variable frequency drive of the driver.

29. A method for controlling a drilling system as claimed in claim 27, wherein the operating one or more of the controllers comprises operating the at least one level 1 (bottom) direct controller.

30. A method for controlling a drilling system as claimed in claim 27, wherein the operating one or more of the controllers comprises operating the at least one level 2 (middle) coordinated controller.

31. A drilling system comprising:
a driver,
a drawworks,
a drillstring;
a drill bit, wherein the driver rotates the drillstring and the drawworks raises/lowers the drillstring during a drilling process to drill a borehole through an earth formation;
controllers in a network comprising:
at least one level 0 (field) variable frequency drive of the driver;
at least one level 1 (bottom) direct controller, wherein the at least one level 0 (field) variable frequency drive and the at least one level 1 (bottom) direct controller communicate via a field bus;
at least one level 2 (middle) coordinated controller, wherein the at least one level 1 (bottom) direct controller and the at least one level 2 (middle) coordinated controller communicate via a real time databus;
wherein each controller comprises a non-transitory storage medium;
a set of computer readable instructions stored in the non-transitory storage medium of at least one of the controllers and when executed by the at least one controller is configured to allow the at least one controller to:
receive drill string status measurements from sensors associated with the drill string near the driver,
execute a slip-stick energy optimization algorithm based on the received drill string status measurements to generate a RPM command, comprising:
setting a desired rotation speed v₀ for the drillstring;
deriving a component vᵤₚ of a rotation speed of the drillstring associated with upgoing rotational energy from the received drill string status measurements;
determining a rotation speed v for the drillstring by optimizing an expression which reconciles two conflicting objectives of: (i) maintaining a stable rotation speed centered on v₀, and (ii) minimizing downgoing rotational energy, the optimized expression expressing v in terms of v₀ and vᵤₚ; and
generating a RPM command for the driver to rotate the drillstring at v; and
operating the driver based on the RPM command.

32. A drilling system as claimed in claim 31, wherein the at least one controller having the set of computer readable instructions stored in its non-transitory storage medium is the at least one level 0 (field) variable frequency drive of the driver.

33. A drilling system as claimed in claim 31, wherein the at least one controller having the set of computer readable instructions stored in its non-transitory storage medium is the at least one level 1 (bottom) direct controller.

34. A drilling system as claimed in claim 31, wherein the at least one controller having the set of computer readable instructions stored in its non-transitory storage medium is the at least one level 2 (middle) coordinated controller.

35. A method for estimating drilling parameters via an autodriller, the method comprising:
drilling a wellbore with a drilling system controlled by the autodriller under a first control parameter;
changing the first control parameter;
observing changes in the drilling system in response to the changed first control parameter;
combining data reflecting the observed changes in the drilling system;
estimating an exponential decay factor based on the combined data;
deriving second control parameter from the estimated decay factor; and
drilling the wellbore with the drilling system controlled by the autodriller under the second control parameter.

36. A method as claimed in claim 35, wherein the first control parameter is rate of penetration.

37. A method as claimed in claim 35, wherein the first control parameter is weight on bit.

38. A method as claimed in claim 35, wherein the first control parameter is pressure.
